(19) United States
(12) Patent Application Publication
(10) Pub. No.: US 2009/0278744 A1
(43) Pub. Date: Nov. 12, 2009

(54) PHASED ARRAY ANTENNA

(75) Inventors: Hideki Kirino, Kagawa (JP); Kouichi Hiranaka, Ehime (JP); Takeshi Hatakeyama, Ehime (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/090,024

(22) PCT Filed: Oct. 11, 2006
(86) PCT No.: PCT/JP2006/320344

§ 371 Date: Apr. 11, 2008

(30) Foreign Application Priority Data
Oct. 11, 2005 (JP) 2005-296863
Apr. 20, 2006 (JP) 2006-117262

(51) Int. Cl. H01Q 1/38

(52) U.S. Cl. 343/700 MS

(57) ABSTRACT

There is provided a phased array antenna having variable phase shifters constituted by using a variable dielectric-constant dielectric substance whose dielectric constant varies according to an applied electric field, which antenna can dispense with a DC blocking element that causes mismatch, and reduce deformation of the beam shape even when beam tilt occurs, in the case where the variable phase shifters are divided into those for right-side tilt and those for left-side tilt and the phase shift amounts thereof are independently controlled.

The phased array antenna is provided with a feeding phase shift unit (130) having a laminated structure obtained by laminating at least a ground conductor layer (117), an insulator layer (118), a main conductor layer (119), a variable dielectric-constant dielectric layer (120), and a sub conductor layer (121) in this order, and a propagation characteristic variable line (105) having a line on the sub conductor layer in an area which planarly overlaps a line on the main conductor layer is provided on the feeding phase shift unit. By applying a bias voltage between the main conductor layer and the sub conductor layer, the dielectric constant of the variable dielectric-constant dielectric substance in the propagation characteristic variable line area is varied to control the propagation characteristics. Thereby, a DC blocking element to be inserted in series into the feeding line can be dispensed with.

### TECHNICAL FIELD

The present invention relates to a phased array antenna. More specifically, the invention relates to a technique for realizing a phased array antenna having variable phase shifters constituted by using a variable dielectric-constant dielectric substance whose dielectric constant varies according to an applied electric field, which can maintain a high directional gain with less deformation of beam shape even when beam tilt occurs.

### BACKGROUND ART

1) Initially, a first background art will be described

As a conventional phased array antenna having variable phase shifters constituted by using a variable dielectric-constant dielectric substance whose dielectric constant varies according to an applied electric field, there is a phased array antenna constructed such that variable phase shifters are divided into two groups for right-side tilt and left-side tilt, and the phase shift amounts thereof are independently controlled to reduce variations in the electric powers supplied to the respective antenna elements as well as variations in the phase shifts, thereby maintaining a high directional gain without deforming the sharp beam shape even when beam tilt occurs (for example, refer to FIG. 4 of Patent Document 1).

Further, as a conventional phased array antenna having variable phase shifters constituted by using a variable dielectric-constant dielectric substance whose dielectric constant varies according to an applied electric field, there is a phased array antenna constructed such that a propagation characteristic variable line is constituted using a variable dielectric-constant dielectric substance as a support insulator for a front end open line in each variable phase shifter, and a voltage is applied between the propagation characteristic variable line conductor and a ground conductor to vary the propagation characteristics of the propagation characteristic variable line, thereby controlling the phase shift amount of the variable phase shifter (for example, refer to Patent Document 2).

Furthermore, there is a phased array antenna in which a variable phase shifter area is constituted so as to have a double-layer microstrip line structure, and a variable dielectric-constant dielectric substance is used as a support insulator for one of the layers to constitute a propagation characteristic variable line, and line conductors of the both layers are connected via a through-hole (refer to embodiment 1 and FIG. 1 of Patent Document 1), or the line conductors of the both layers are connected by electromagnetic binding (refer to embodiment 2 and FIG. 2 of Patent Document 1), and a voltage is applied between the propagation characteristic variable line conductor and a ground conductor to vary the propagation characteristics of the propagation characteristic variable line, thereby controlling the phase shift amount of each variable phase shifter.

Hereinafter, the conventional phased array antenna will be described with reference to drawings.

FIG. 3 is a diagram illustrating an example of dielectric constant change characteristics obtained when an electric field is applied to a variable dielectric-constant dielectric substance, and FIG. 4 is a perspective view of a variable phase shifter using the variable dielectric-constant dielectric substance.

Generally, as shown in FIG. 3, a variable dielectric-constant dielectric substance such as a ferroelectric substance has a property that its dielectric constant varies according to an applied electric field. In order to constitute a variable phase shifter using the variable dielectric-constant dielectric substance, as shown in FIG. 4, in a microstrip line structure wherein a waveguide conductor is laminated on a waveguide insulator 402 disposed on a waveguide ground conductor 401, a hybrid coupler 404 having I/O lines 403a and 403b is fabricated, and front-end open lines of the same length are connected to a pair of isolation ports of the hybrid coupler 404. The variable dielectric-constant dielectric substance is used for only a waveguide insulator 406 on which the front-end open lines are disposed.

Since the direction of an electric field (TEM mode) generated by applying a bias voltage between the waveguide conductors 403 to 405 and the ground conductor 401 in the variable phase shifter 400 is approximately parallel to the direction of an electric field (quasi-TEM mode) generated by a high-frequency electric power which propagates in the microstrip line, the front-end open lines 405 function as propagation characteristic variable lines 405 capable of controlling the propagation characteristics of the high-frequency power which is propagated by the bias voltage.

The bias voltage to be applied between the waveguide conductor 405 on the variable dielectric-constant dielectric substance 406 and the waveguide ground conductor 401 may be input from an arbitrary position on the waveguide conductors 403 to 405 because all of these waveguide conductors constituting the variable phase shifter 400 are continuous conductors which are dc-wise connected.

Since the waveguide insulator in the area where the I/O lines 403 and the hybrid coupler 404 are formed is a normal insulator whose dielectric constant does not vary according to the applied electric field, it functions as a propagation characteristic fixed line which does not vary the propagation characteristics of the high-frequency power.

In the variable phase shifter 400 thus constituted, a high-frequency signal inputted from the I/O line 403a which is one of the I/O lines 403 is output to the two propagation characteristic variable lines 405 via the hybrid coupler 404. The high-frequency signals reflected at the open ends of the two propagation characteristic variable lines 405 are subjected to a propagation phase delay which reflects the applied bias voltage and again input to the hybrid coupler 404, and the high-frequency signals passing through the hybrid coupler 404 are combined with each other at the other I/O line 403b and outputted.

Further, when the high-frequency signal is inputted from the other I/O line 403b, only the input/output is inverted, and the high-frequency signal is subjected to similar propagation phase delay and outputted to the one I/O line 403a.

Since the propagation characteristic variable line 405 is also dc-wise connected to the I/O lines 403 via the hybrid coupler 404, even when plural variable phase shifters 400 connected in series are used, the same bias voltage can be simultaneously applied to all of the variable phase shifters by applying the bias voltage to an arbitrary position on the continuous waveguide conductors of the mutually connected plural variable phase shifters, thereby realizing a multistage variable phase shifter having a simple construction of the bias circuit.

Next, the principle of the phased array antenna using the above-described variable phase shifters will be described hereinafter.

FIG. 5 shows the principle of the phased array antenna using the above-described variable phase shifters.

Hereinafter, the operation of the phased array antenna when it is used for reception will be described.

In FIG. 5, W1 to W4 show the wave surfaces of arrival waves that arrive the antenna, and each wave surface is subjected to phase shift of Φ (propagation phase delay) while propagating in the space from W1 to W2, from W2 to W3, from W3 to W4.

Paying attention to the wave surface W1, a signal component received by an antenna element 501 is not subjected to phase shift in the space, but it is subjected to phase shift of Φ while passing through each of the three variable phase shifters 505, 506, and 507, and reaches a feeding terminal 509 with the phase shift amount of 3Φ in total.

Further, a signal component received by an antenna element 502 is subjected to phase shift of Φ while propagating in the space from the position W1 to the position W2, and it is subjected to phase shift of Φ while passing through each of the two phase shifters 506 and 507 in the feeding phase shift unit 500, and reaches the feeding terminal 509 with the phase shift amount of 3Φ in total.

Further, a signal component received by an antenna element 503 is subjected to phase shift of 2Φ while propagating in the space from the position W1 to the position W3, and it is subjected to phase shift of Φ while passing through one variable phase shifter 508 in the feeding phase shift unit 500, and reaches the feeding terminal 509 with the phase shift amount of 3Φ in total.

Further, a signal component received by an antenna element 504 is subjected phase shift of 3Φ while propagating in the space from the position W1 to the position W4, and it is not subjected to phase shift in the feeding phase shift unit 500 because it passes through no variable phase shifter, and reaches the power feeding terminal 509 with the phase shift amount of 3Φ in total.

That is, the above-mentioned phased array antenna has the function of synthesizing the arrival electric waves having the wave surface W1 with the same phase at the feeding terminal 509, thereby forming a main beam in the arrival direction shown by Θ in FIG. 5. That is, it operates as an antenna having a directionality in the arrival direction shown by Θ.

Since the phase shifters 505 to 508 in the feeding phase shift unit 500 are variable phase shifters having the same characteristics, the sample phase shift amount is obtained for the same control voltage value, and therefore, the phase shifters have one main beam for any control voltage value. Further, since the feeding circuit unit 500 is constituted by the continuous conductors that are dc-wise connected, the main beam direction can be varied with one bias voltage 510.

As seen from FIG. 5, the main beam direction Θ satisfies the following relationship, with the phase shift amount Φ of the variable phase shifter and the antenna element interval d,

Θ=arccos(Φ/d)

Next, a description will be given of a phased array antenna shown in FIG. 4 of Patent Document 1 with reference to FIG. 6, as an example of a method which can reduce variations in the electric power distributed to the respective antenna elements as well as variations in the phase shift, and maintain a high directional gain without deforming the sharp beam shape even when beam tilt occurs, by separating variable phase shifters into two groups for right-side tilt and left-side tilt and controlling the phase shift amounts independently from each other while having the above-mentioned beam control principle.

FIG. 6 is a layout diagram of variable phase shifters in a phased array antenna disclosed in FIG. 4 of Patent Document 1, wherein 600 denotes a feeding phase shift unit, 601 denotes a feeding terminal, 602 (602a to 602d) denote variable phase shifters for right-side tilt, 603 (603a to 603d) denote variable phase shifters for left-side tilt, 604 denotes a bias voltage for right-side tilt, 605 denotes a bias voltage for left-side tilt, 606 (606a to 606d) denote antenna elements, 607 denotes a DC blocking element for transmitting a high-frequency signal and separating the right-side tilt bias voltage from the left-side tilt bias voltage, and 608 denotes a high-frequency blocking element for applying the bias voltage to the respective variable phase shifters and blocking the high-frequency signal.

While the variable phase shifters are asymmetrically arranged in the principle of the phased array antenna shown in FIG. 5, in the construction shown in FIG. 6 the numbers of variable phase shifters disposed between the feeding terminal and the respective antenna elements differ from each other. Further, since each variable phase shifter has a dielectric loss, an insertion loss due to a conductor loss, and a reflection loss due to mismatching, the electric powers distributed to the respective antenna elements and the phases undesirably vary, resulting in a difficulty in obtaining a symmetrical beam shape.

As a method for solving such problem, in the construction shown in FIG. 6 which is identical to the construction shown in FIG. 4 of Patent Document 1, the variable phase shifters provided between the feeding terminal 601 and the respective antenna elements 606a to 606d are made the same in kind and the same in number with respect to all the paths, and the layout of the variable phase shifters is made symmetrical.

As for the beam control, there is adopted a method of dividing all the variable phase shifters into two groups, i.e., the variable phase shifters for right-side tilt and the variable phase shifters for left-side tilt, and controlling the respective groups with independent bias voltages 604 and 605.

As can be seen from FIG. 6, assuming that the phase shift amount of the right-side tilt variable phase shifter is ΦR and the phase shift amount of the left-side tilt variable phase shift is ΦL, the sum of the phase shift amounts the wave surface W1 receives in the space and in the feeding phase shift unit 600 until it arrives the feeding terminal 601 is,

for the component received by the antenna element 606a,

0×(ΦR−ΦL)[in the space]+3×ΦR+0×ΦL[in the feeding phase shifter]=3ΦR,

for the component received by the antenna element 606b,

1×(ΦR−ΦL)[in the space]+2×ΦR+1×ΦL[in the feeding phase shifter]=3ΦR,

for the component received by the antenna element 606c,

2×(ΦR−ΦL)[in the space]+1×ΦR+2×ΦL[in the feeding phase shifter]=3ΦR, and

for the component received by the antenna element 606d,

3×(ΦR−ΦL)[in the space]+0×ΦR+3×ΦL[in the feeding phase shifter]=3ΦR.

Since all the components are synthesized with the same phase of 3ΦR, assuming that the antenna element interval is d, the main beam direction Θ satisfies the following relationship, as in the case of FIG. 5,

Θ=arccos((ΦR−ΦL)/d)

Next, the construction of the phased array antenna disclosed in Patent Document 2 and Patent Document 1 which has the above-described principle will be described with reference to FIG. 7.

FIG. 7(a) shows a plan view and cross-sectional views of the multilayer-structure phased array antenna disclosed in Patent Document 2.

In FIG. 7(a), a diagram positioned at the top is a plan view of the antenna viewed from the radiation plane side. Subsequently, a A-A cross-sectional view, a B-B cross-sectional view, and a C-C cross-sectional view showing the states of cross sections obtained when the antenna is cut along a A-A line, a B-B line, and a C-C line in the plan view, respectively, are illustrated toward the bottom in the figure.

That is, the A-A cross-sectional view, the B-B cross-sectional view, and the C-C cross-sectional view are obtained by dividing the cross-sectional view of the active phased array antenna shown in FIG. 4 of Patent Document 2 into the cross sections for the respective areas.

Further, the plan view in FIG. 7(a) is obtained by extracting an area of a broken-line part 609 shown in FIG. 6, and the display direction of the plan view is obtained by rotating FIG. 6 clockwise at 90°.

Further, in this plan view, patterns 704 and 705 included in the phase shifter 602 shown in FIG. 6, i.e., corresponding to the hybrid coupler 404 and the propagation characteristic variable line 405 shown in FIG. 4, and a pattern 706 corresponding to the DC blocking element 607 shown in FIG. 6, and a pattern 707 corresponding to the high frequency blocking element 608 shown in FIG. 6 are illustrated with broken lines.

Further, in this plan view, 708 denotes an antenna element, 709 denotes an input terminal, 710 denotes a bias terminal, 711 denotes a feeding line pattern, and 712 denotes a binding window of the feeding line pattern 711 and the antenna element 708, and these areas constitute a propagation characteristic fixed line whose propagation characteristics against a high frequency do not vary even when a bias voltage is applied.

On the other hand, in the A-A cross-sectional view, the B-B cross-sectional view, and the C-C cross-sectional view in FIG. 7(a), the layer structure constituting the antenna and the members (constituents) thereof are shown.

In the A-A cross-sectional view, the B-B cross-sectional view, and the C-C cross-sectional view, 713 to 716 are constituents of a plane waveguide structure which constitutes the antenna unit. To be specific, 713 denotes an insulating layer for supporting the antenna element, 714 denotes a conductor layer constituting the antenna element, 715 denotes an air layer for an insulator which is required for constituting the plane waveguide structure, and 716 denotes a ground conductor layer required for constituting the plane waveguide structure.

Further, 716 to 719 are constituents of a plane waveguide structure which constitutes the feeding phase shift unit. To be specific, 716 denotes a ground conductor laser required for constituting the plane waveguide structure, and this is shared with the antenna unit. Further, 717 denotes an air layer for an insulator which is required for constituting the plane waveguide structure, 718 denotes a conductor layer constituting the respective patterns of the feeding phase shift unit, 719 denotes an insulator layer for supporting the patterns of the feeding phase shift unit, and 720 denotes a variable dielectric-constant dielectric substance for the propagation characteristic variable line.

As for the conductor layers 714, 716, and 718, the respective layers are independently illustrated in FIG. 7(b) so that the pattern configuration of each layer can be easily understood.

In the phased array antenna constituted as described above which is disclosed in Patent Document 2, as shown in the A-A cross-sectional view, the B-B cross-sectional view, and the C-C cross-sectional view, a first inverted type (also known as suspended type) microstrip structure for the antenna unit is constituted by the four layers comprising the insulator layer 713, the conductor layer 714, the air layer 715, and the ground conductor layer 716, while a second inverted microstrip structure for the feeding phase shift unit is constituted by the four layers comprising the ground conductor layer 716, the air layer 717, the conductor layer 718, and the insulator layer 719.

Further, as shown in the plan view, the antenna element 708 (714 in the A-A line cross section) and the feeding line pattern 711 (718 in the A-A line cross section) are electromagnetically connected to each other via the binding window 712 (the binding window 721 in the A-A cross section) which is formed on the ground conductor layer 716 that is shared by the antenna unit and the feeding phase shift unit, thereby to exchange the high frequency power.

Further, by applying a bias voltage to between the bias terminal 710 formed on the conductor layer 718 and the ground conductor layer 716, the bias voltage is applied to the propagation characteristic variable line 705 via the high-frequency blocking element pattern 707, the feeding line pattern 711, and the hybrid coupler pattern 704.

Since the direction of the electric field (quasi TEM mode) generated by the high frequency power that propagates in the propagation characteristic variable line 705 and the direction of the electric field (TEM mode) generated by the bias voltage are approximately parallel to each other, the propagation characteristics of the high frequency power propagating on the propagation characteristic variable line 705 can be controlled with the bias voltage.

FIG. 8(a) shows a plan view and cross-sectional views of the multilayer-structure phased array antenna disclosed in embodiment 1 of Patent Document 1.

In FIG. 8(a), a diagram positioned at the top is a plan view of the antenna viewed from the radiation plane side. Subsequently, a A-A cross-sectional view, a B-B cross-sectional view, and a C-C cross-sectional view showing the states of cross sections obtained when the antenna is cut along a A-A line, a B-B line, and a C-C line in the plan view, respectively, are illustrated toward the bottom in the figure.

That is, the A-A cross-sectional view, the B-B cross-sectional view, and the C-C cross-sectional view are obtained by dividing the active phased array antenna shown in FIG. 1 of Patent Document 1 to which the structure of the antenna unit is added, into the cross sections corresponding to the respective areas.

The display area of the plan view shown in FIG. 8(a) is identical to that shown in FIG. 7(a).

Further, in this plan view, a pattern 804 of the hybrid coupler, a pattern 805 of the propagation characteristic variable line, a pattern 806 of the DC blocking element, and a pattern 807 of the high-frequency blocking element are illustrated with broken lines.

Further, in this plan view, 808 denotes an antenna element, 809 denotes an input terminal, 810 denotes a bias terminal, 811 denotes a feeding line pattern, 812 denotes a binding window of the feeding line pattern 811 and the antenna element 808, and 813 denotes a through-hole connecting the feeding line pattern 811 and the propagation characteristic variable line patter 805, and these areas as well as the area of the hybrid coupler 804 constitute a propagation characteristic fixed line whose propagation characteristics against a high frequency do not vary even when a bias voltage is applied.

On the other hand, in the A-A cross-sectional view, the B-B cross-sectional view, and the C-C cross-sectional view in FIG. 8(a), the layer structure constituting the antenna and the constituent members thereof are shown.

In the A-A cross-sectional view, the B-B cross-sectional view, and the C-C cross-sectional view, 814 to 817 are constituents of a plane waveguide structure which constitutes the antenna unit. To be specific, 814 denotes an insulating layer for supporting the antenna element, 815 denotes a conductor layer constituting the antenna element, 816 denotes an air layer for an insulator which is required for constituting the plane waveguide structure, and 817 denotes a ground conductor layer required for constituting the plane waveguide structure.

Further, 819 to 821 are constituents of a plane waveguide structure which constitutes the feeding phase shift unit other than the propagation characteristic variable line. To be specific, 819 denotes a conductor laser constituting the respective patterns in the feeding phase shift unit other than the propagation characteristic variable line, 820 denotes a dielectric layer for an insulator required for constituting the plane waveguide structure, and 821 denotes a ground conductor layer required for constituting the plane waveguide structure.

Further, 821 to 823 are constituents of a plane waveguide structure which constitutes the propagation characteristic variable line. To be specific, 821 denotes a ground conductor required for constituting the plane waveguide structure, and this is shared with the feeding phase shift unit. Further, 822 denotes a variable dielectric-constant dielectric layer required for constituting the plane waveguide structure, and 823 denotes a conductor layer constituting the propagation characteristic variable line.

Further, 818 denotes an air layer as an intermediate layer which connects the plane waveguide structure of the antenna unit and the plane waveguide structure of the feeding phase shift unit.

With respect to the five conductor layers 815, 817, 819, 821, and 823, the respective layers are independently illustrated in FIG. 8(b) so that the pattern configuration of each layer can be easily understood.

In the phased array antenna constituted as described above which is disclosed in Patent Document 1, as shown in the A-A cross-sectional view, the B-B cross-sectional view, and the C-C cross-sectional view, a first inverted type (also known as suspended type) microstrip structure for the antenna unit is constituted by the four layers comprising the insulator layer 814, the conductor layer 815, the air layer 816, and the ground conductor layer 817, and a second microstrip structure for the feeding phase shift unit other than the propagation characteristic variable line is constituted by the three layers comprising the conductor layer 819, the dielectric layer 820, and the ground conductor layer 821, and further, a third microstrip structure for the propagation characteristic variable line is constituted by the three layers comprising the ground conductor layer 821, the variable dielectric-constant dielectric layer 822, and the conductor layer 823.

Further, as shown in the plan view, the antenna element 808 (815 in the A-A line cross section) and the feeding line pattern 811 (819 in the A-A line cross section) are electromagnetically connected to each other via the binding window 812 (the binding window 824 in the A-A cross section) which is formed on the ground conductor layer 817 in the antenna unit, and exchange the high frequency power. Further, the feeding line pattern 811 (819 in the A-A cross-sectional view) and the propagation characteristic variable line pattern 805 (823 in the C-C cross-sectional view) are connected to each other via the through-hole 813 (825 in the B-B cross-sectional view).

Further, by applying a bias voltage to between the bias terminal 810 formed on the conductor layer 819 and the ground conductor layer 821, the bias voltage is applied to the propagation characteristic variable line 805 via the high-frequency blocking element pattern 807, the feeding line pattern 811, and the hybrid coupler pattern 804.

Since the direction of the electric field (quasi TEM mode) generated by the high frequency power that propagates in the propagation characteristic variable line 805 and the direction of the electric field (TEM mode) generated by the bias voltage are approximately parallel to each other, the propagation characteristics of the high frequency power propagating on the propagation characteristic variable line 805 can be controlled with the bias voltage.

FIG. 9(a) shows a plan view and cross-sectional views of the multilayer-structure phased array antenna disclosed in embodiment 2 of Patent Document 1.

In FIG. 9(a), a diagram positioned at the top is a plan view of the antenna viewed from the radiation plane side. Subsequently, a A-A cross-sectional view, a B-B cross-sectional view, and a C-C cross-sectional view showing the states of cross sections obtained when the antenna is cut along a A-A line, a B-B line, and a C-C line in the plan view, respectively, are illustrated toward the bottom in the figure.

That is, the A-A cross-sectional view, the B-B cross-sectional view, and the C-C cross-sectional view are obtained by dividing the structure of the phase shifter shown in FIG. 2 of Patent Document 1 to which the structure of the antenna unit is added, into the cross sections corresponding to the respective areas.

The display area of the plan view is identical to that shown in FIG. 7(a).

Further, in this plan view, a pattern 904 of the hybrid coupler, and a pattern 905 of the propagation characteristic variable line are illustrated with broken lines.

Further, in this plan view, 906 denotes an antenna element, 907 denotes an input terminal, 908 denotes a bias terminal, 909 denotes a feeding line pattern, 910 denotes a binding window of the feeding line pattern 909 and the antenna element 906, 911 denotes a pattern corresponding to a DC blocking element, 912 denotes a binding window for electromagnetically binding the DC blocking element patter 911 and the propagation characteristic variable line pattern 905, and 913 denotes a pattern corresponding to a high-frequency blocking element, and these areas as well as the area of the hybrid coupler 904 constitute a propagation characteristic fixed line whose propagation characteristics against a high frequency do not vary even when a bias voltage is applied.

On the other hand, in the A-A cross-sectional view, the B-B cross-sectional view, and the C-C cross-sectional view in FIG. 9(a), the layer structure constituting the antenna and the constituent members thereof are shown.

In the A-A cross-sectional view, the B-B cross-sectional view, and the C-C cross-sectional view, 914 to 917 are constituents of a plane waveguide structure which constitutes the antenna unit. To be specific, 914 denotes an insulating layer for supporting the antenna element, 915 denotes a conductor layer constituting the antenna element, 916 denotes an air layer for an insulator which is required for constituting the plane waveguide structure, and 917 denotes a ground conductor layer required for constituting the plane waveguide structure.

Further, 919 to 921 are constituents of a plane waveguide structure which constitutes the feeding phase shift unit other than the propagation characteristic variable line. To be specific, 919 denotes a conductor laser constituting the respective patterns in the feeding phase shift unit other than the propagation characteristic variable line, 920 denotes a dielectric layer for an insulator required for constituting the plane waveguide structure, and 921 denotes a ground conductor layer required for constituting the plane waveguide structure.

Further, 921 to 923 are constituents of a plane waveguide structure which constitutes the propagation characteristic variable line. To be specific, 921 denotes a ground conductor required for constituting the plane waveguide structure, and this is shared with the feeding phase shift unit. Further, 922 denotes a variable dielectric-constant dielectric layer required for constituting the plane waveguide structure, and 923 denotes a conductor layer constituting the propagation characteristic variable line.

Further, 918 denotes an air layer as an intermediate layer which connects the plane waveguide structure of the antenna unit and the plane waveguide structure of the feeding phase shift unit.

With respect to the five conductor layers 915, 917, 919, 921, and 923, the respective layers are independently illustrated in FIG. 9(b) so that the pattern configuration of each layer can be easily understood.

In the phased array antenna constituted as described above which is disclosed in embodiment 2 of Patent Document 1, as shown in the A-A cross-sectional view, the B-B cross-sectional view, and the C-C cross-sectional view, a first inverted type (also known as suspended type) microstrip structure for the antenna unit is constituted by the four layers comprising the insulator layer 914, the conductor layer 915, the air layer 916, and the ground conductor layer 917, and a second microstrip structure for the feeding phase shift unit other than the propagation characteristic variable line is constituted by the three layers comprising the conductor layer 919, the dielectric layer 920, and the ground conductor layer 921, and further, a third microstrip structure for the propagation characteristic variable line is constituted by the three layers comprising the ground conductor layer 921, the variable dielectric-constant dielectric layer 922, and the conductor layer 923.

Further, as shown in the plan view, the antenna element 906 (915 in the A-A line cross section) and the feeding line pattern 909 (919 in the A-A line cross section) are electromagnetically connected to each other via the binding window 910 (924 in the A-A cross section) which is formed on the ground conductor layer 917 in the antenna unit, and exchange the high frequency power. Further, the feeding line pattern 909 (919 in the A-A cross-sectional view) and the propagation characteristic variable line pattern 905 (923 in the C-C cross-sectional view) are connected to each other via the binding window 912 (926 in the B-B cross-sectional view) formed on the ground conductor layer 921 (shared with the feeding phase shift unit) which is required for constituting the plane waveguide structure, and the pattern 911 corresponding to the DC blocking element (925 in the B-B cross-sectional view) and the propagation characteristic variable line pattern 905 (923 in the C-C cross-sectional view) are electromagnetically connected to each other, thereby blocking the direct current (bias voltage) as the control voltage for the variable phase shifter, and performing exchange of the high-frequency power.

Further, by applying a bias voltage to between the bias terminal 908 formed on the conductor layer 923 and the ground conductor layer 921, the bias voltage is applied to the propagation characteristic variable line 905 via the high-frequency blocking element pattern 913.

Since the direction of the electric field (quasi TEM mode) generated by the high frequency power that propagates in the propagation characteristic variable line 905 and the direction of the electric field (TEM mode) generated by the bias voltage are approximately parallel to each other, the propagation characteristics of the high frequency power propagating on the propagation characteristic variable line 905 can be controlled with the bias voltage.

2) Next, a second background art will be described.

In a variable phase shifter constituted by using a variable dielectric-constant dielectric substance whose dielectric constant varies according to an applied voltage, the variable dielectric-constant dielectric substance functions as a microstrip line that can be regarded as a dielectric substrate. By applying a control voltage between such microstrip line and a metal electrode serving as a ground conductor (ground surface), the molecular orientation of the variable dielectric-constant dielectric substance varies.

In this case, since the variable dielectric-constant dielectric substance has a dielectric anisotropy due to the molecular orientation, if the molecular orientation varies, the dielectric constant to an electromagnetic wave that propagates in the microstrip line varies. A phase delay φ based on the propagation delay which occurs when the electromagnetic wave propagates in the microstrip line having a length l is represented as follows:

φ=2πf·√(∈eff)·l/c (1)

wherein ∈eff is the equivalent dielectric constant of the microstrip line, f is the frequency of the electromagnetic wave that propagates in the microstrip line, and c is the velocity of light in vacuum.

As a conventional phased array antenna having such variable phase shifters, there is a phased array antenna in which the variable phase shifters are divided into two groups for right-side tilt and left-side tilt, and the phase shift amounts thereof are independently controlled to reduce variations in the electric powers supplied to the respective antenna elements as well as variations in the phase shifts, thereby maintaining a high directional gain without deforming the sharp beam shape even when beam tilt occurs (for example, refer to Patent Document 1).

Further, as a conventional phased array antenna having variable phase shifters constituted by using a variable dielectric-constant dielectric substance whose dielectric constant varies according to an applied electric field, there is a phased array antenna in which a propagation characteristic variable line is constituted using a variable dielectric-constant dielectric substance as a support insulator for a front end open line in each variable phase shifter, and a voltage is applied between the propagation characteristic variable line conductor and a ground conductor to vary the propagation characteristics of the propagation characteristic variable line, thereby controlling the phase shift amount of the variable phase shifter (for example, refer to Patent Document 2).

Furthermore, there is a phased array antenna in which a variable phase shifter area is constituted so as to have a double-layer microstrip line structure, and a propagation characteristic variable line is constituted by using a variable dielectric-constant dielectric substance as a support insulator for one of the two layers, and line conductors of the both layers are connected via a through-hole or by electromagnetic binding, and a voltage is applied between the propagation characteristic variable line conductor and a ground conductor to generate a phase delay in the electromagnetic wave in the propagation characteristic variable line, thereby controlling the phase shift amount of each variable phase shifter (for example, refer to Patent Document 1).

On the other hand, a variable phase shifter utilizing a nematic liquid crystal as a variable dielectric-constant dielectric substance is reported as a microwave band variable phase shifter by D. Dolfi, M. Labeyrie, P. Joffre and P. Huiqard (refer to Non-patent Document 1).

In Non-Patent Document 1, a nematic liquid crystal is sandwiched by two ceramics substrates, and a control voltage is applied between a main conductor (line) formed on one ceramics substrate and a ground conductor formed on the other ceramics substrate to generate a phase delay in an electromagnetic wave that propagates in a microstrip line comprising the nematic liquid crystal, thereby realizing a phase shifter.

In such phase shifter, in order to steer a radiation beam at predetermined time intervals, it is necessary to vary the dielectric constant of the liquid crystal at a predetermined speed.

In order to enhance the voltage responsivity of the liquid crystal molecules while the voltage is off, there is proposed a method of disposing a resin complex obtained by dispersing a liquid crystal into a resin, between the conductors on the two substrates in the variable phase shifter, instead of the liquid crystal which is publicly known in the field of liquid crystal display devices (for example, refer to Patent Document 3).

Further, there is proposed a construction in which a variable phase shifter including a liquid crystal is constituted as a resonator type phase shifter, and a liquid crystal layer thereof is constituted by a fiber dielectric substance obtained by impregnating a plate-shaped member or a porous film with a liquid crystal (for example, refer to Patent Document 4).

In order to constitute a variable phase shifter using a variable dielectric-constant dielectric substance, as shown in FIG. 19, in a microstrip line structure wherein a waveguide conductor is laminated on a waveguide insulator 402 disposed on a waveguide ground conductor 401, a hybrid coupler 404 having I/O lines 403a and 403b is fabricated, and front-end open lines of the same length are connected to a pair of isolation ports of the hybrid coupler 404. The variable dielectric-constant dielectric substance is used for only a waveguide insulator 406 on which the front-end open lines are disposed.

Here, the direction of an electric field (TEM mode) generated by applying a bias voltage between the waveguide conductors 403 to 405 and the ground conductor 401 in the variable phase shifter 400 is approximately parallel to the direction of an electric field (quasi-TEM mode) generated by a electromagnetic wave which propagates in the microstrip line, the front-end open lines 405 function as propagation characteristic variable lines 405 capable of controlling the phase of the electromagnetic wave which is propagated by the bias voltage.

In the variable phase shifter 400 thus constituted, an electromagnetic wave inputted from the I/O line 403a which is one of the I/O lines 403 is output to the two propagation characteristic variable lines 405 via the hybrid coupler 404. The electromagnetic waves reflected at the open ends of the two propagation characteristic variable lines 405 are subjected to a propagation phase delay which reflects the applied bias voltage and again input to the hybrid coupler 404, and the electromagnetic waves passing through the hybrid coupler 404 are combined with each other at the other I/O line 403b and outputted.

Since the propagation characteristic variable lines 405 are also dc-wise connected to the I/O lines 403 via the hybrid coupler 404, even when plural variable phase shifters 400 connected in series are used, the same bias voltage can be simultaneously applied to all of the variable phase shifters by applying the bias voltage to an arbitrary position on the continuous waveguide conductors of the mutually connected plural variable phase shifters, thereby realizing a multistage variable phase shifter having a simple construction of the bias circuit.

Patent Document 1: Japanese Published Patent Application No. 2004-23228

Patent Document 2: Japanese Published Patent Application No. 2000-236207

Patent Document 3: Japanese Published Patent Application No. 2000-315902

Patent Document 4: Japanese Published Patent Application No. 2003-17912

Non-patent Document 1: D. Dolfi, M. Labeyrie, P. Joffre and P. Huiqard, “Liquid crystal microwave phase shifter”, Electron. Lett., Vol. 29, No. 10, pp. 926-927, 1999

### DISCLOSURE OF THE INVENTION

### Problems to be Solved by the Invention

However, the configuration of the conventional phased array antenna described with respect to the first background art has a first problem that it is difficult to maintain a high directional gain without deforming the beam shape even when beam tilt occurs.

That is, in the conventional phased array antenna, in order to realize a high directional gain with a symmetrical beam shape, the variable phase shifters are divided into the variable phase shifters for right-side tilt and the variable phase shifters for left-side tilt as shown in FIG. 6 so that the phase shift amounts thereof can be controlled independently from each other. In this construction, however, in order to dc-wise separate the both bias voltages, the feeding phase shift unit disclosed in Patent Document 2 and embodiment 1 of Patent Document 1 requires a pattern of a DC blocking element on the feeding line pattern. Further, the feeding phase shift unit disclosed in embodiment 2 of Patent Document 1 requires a pattern of a DC blocking element for electromagnetically combining the feeding line with the propagation characteristic variable line.

In these cases, however, since mismatches in the plural DC blocking elements inserted in the line for propagating the high frequency signal are undesirably accumulated, even if the feeding phase shift unit is designed so as to have a high directional gain when the beam tilt amount is zero, i.e., when the beam is in the front direction, it merely cancels the accumulation of the mismatches due to the DC blocking elements by addition of the elements or optimization of the line parameters. Therefore, if the accumulation state of the mismatches changes when beam tilt occurs, the mismatch accumulation canceled state is collapsed, and thereby the beam shape is deformed, resulting in a difficulty in maintaining a high directional gain.

Further, the inventors of the present invention have discovered the following problem (second problem) as a result of examination on the prior art described for the second background art.

When the conventional variable phase shifter adopts, as a variable dielectric-constant dielectric layer, a liquid crystal, or a material including a liquid crystal, i.e., a complex of a liquid crystal and a resin, or a fiber dielectric substance that is obtained by impregnating a plate-shaped member or a porous film with a liquid crystal, it is necessary to uniformly inject the liquid crystal into the variable dielectric-constant dielectric layer, but the above-mentioned background art does not describe any measure which enables this point.

Accordingly, if the background art is executed as it is, the phase characteristics vary, and thereby variations occur in the variable dielectric constant characteristics of the plural variable phase shifters, resulting in deformation of the beam shape during beam tilt, and reduction in the beam directionality.

To be specific, air bubbles are introduced when the liquid crystal is injected into a container to be a variable phase shifter, and if an electric field is applied in this state, the air bubbles move according to the electric field, resulting in variations in the phase characteristics of the individual phase shifters. Further, when the liquid crystal is subjected to an orientation processing, the direction thereof cannot be made uniform after the injection. Further, when forming a complex of a liquid crystal and a resin, a reaction between them cannot be realized at the same rate.

As described above, in the phased array antenna having the plural variable phase shifters constituted by using the variable dielectric-constant dielectric substance whose dielectric constant varies due to applied voltage, in order to realize an antenna which can maintain a high directional gain with less deformation of the beam shape even when beam tilt occurs,

firstly, it is necessary to constitute the feeding phase shift unit by plural independent variable-dielectric-constant dielectric layers, and

secondly, it is necessary to fabricate variable phase shifters having the same variable dielectric constant characteristic.

Further, with respect to the characteristics of the material of the variable dielectric-constant dielectric layer, a material having a low dielectric loss is desirable. Further, a material having a high electromagnetic connectivity between the variable dielectric-constant dielectric substance and a fixed dielectric-constant dielectric substance as an ordinary substrate, i.e., a material having a dielectric constant close to that of the substrate, is desirable. With respect to a voltage to be applied to the variable dielectric-constant dielectric substance, a material which can vary the dielectric constant with a low voltage not larger than 100V is desirable although it depends on the actual application of the antenna.

The present invention is made to solve the above-described first problem and has for its object to provide a phased array antenna having variable phase shifters constituted by using a variable dielectric-constant dielectric substance whose dielectric constant varies according to an applied electric field, which antenna requires no DC blocking element that causes a mismatch, and thereby maintains a high directional gain with less deformation of the beam shape even when beam tilt occurs, in the case where the antenna is constituted such that the variable phase shifters are divided into variable phase shifters for right-side tilt and variable phase shifters for left-side tilt as shown in FIG. 6 and the phase shift amounts thereof are independently controlled to realize a high directional gain.

Further, the present invention is conceived in view of the above-described second problem and has for its object to provide a phased array antenna using, as a variable dielectric-constant dielectric substance for constituting plural variable phase shifters which constitute the phased array antenna, a liquid crystal, or a material containing a liquid crystal such as a complex of a liquid crystal and an inorganic material or a complex of a liquid crystal and a resin as an organic maternal, or a fiber dielectric substance obtained by impregnating a plate-shaped member or a porous film with a liquid crystal, which antenna can reduce variations in the dielectric constants of the variable dielectric-constant dielectric layers among the plural variable phase shifters, and maintain a high directional gain with less deformation of the beam shape even when beam tilt occurs.

### Measures to Solve the Problems

In order to solve the conventional problem 1, according to Claim 1 of the present invention, there is provided a phased array antenna having variable phase shifters constituted by using a variable dielectric-constant dielectric substance whose dielectric constant varies according to an applied electric field, which phased array antenna includes a feeding phase shift unit having a laminated structure formed by laminating at least a ground conductor layer, an insulator layer, a main conductor layer, a variable dielectric-constant dielectric layer, and a sub conductor layer in this order.

Further, according to Claim 2 of the present invention, in the phased array antenna defined in Claim 1, the feeding phase shift unit includes a propagation characteristic fixed line which does not vary the propagation characteristics of a high-frequency power, and a propagation characteristic variable line which varies the propagation characteristics of the high-frequency power.

Further, according to Claim 3 of the present invention, in the phased array antenna defined in Claim 2, the propagation characteristic fixed line has no line in an area on the sub conductor layer which corresponds to a line provided on the main conductor layer, and propagates an electric field produced by the high-frequency power that propagates in the line provided on the main conductor layer, concentratedly to between the main conductor layer and the ground conductor layer, the propagation characteristic variable line has a line in the area on the sub conductor layer which corresponds to the line provided on the main conductor layer, and propagates the electric field produced by the high-frequency power that propagates in the line provided on the main conductor layer, dispersively to between the main conductor layer and the ground conductor layer and to between the main conductor layer and the sub conductor layer, and the propagation characteristic fixed line and the propagation characteristic variable line are constituted as continuous conductors on the main conductor layer.

Further, according to Claim 4 of the present invention, in the phased array antenna defined in Claim 3, the propagation characteristic variable line applies a bias voltage to between the main conductor layer and the sub conductor layer to vary the dielectric constant of the variable dielectric-constant dielectric substance constituting the variable dielectric-constant dielectric layer, thereby controlling the propagation characteristics of the high-frequency power.

Further, according to Claim 5 of the present invention, in the phased array antenna defined in Claim 1, the variable dielectric-constant dielectric layer comprises a liquid crystal or a material including a liquid crystal.

Further, according to Claim 6 of the present invention, in the phased array antenna defined in Claim 1, the laminated structure includes a second insulator layer which is disposed on a side of the sub conductor layer opposite to the variable dielectric-constant dielectric layer, and the variable dielectric-constant dielectric layer is held in a hermetically-sealed space which is formed between the insulator layer and the second insulator layer.

Further, according to Claim 7 of the present invention, there is provided a phased array antenna having variable phase shifters constituted by using a variable dielectric-constant dielectric substance whose dielectric constant varies according to an applied voltage, which phased array antenna includes a feeding phase shift unit having a laminated structure obtained by laminating at least a ground conductor layer, an insulator layer, a propagation characteristic variable line, a variable dielectric-constant dielectric layer, and a bias electrode layer in this order, wherein the feeding phase shift unit includes plural independent variable-dielectric-constant dielectric layers, each variable dielectric-constant dielectric layer has an open hole, and the open hole is formed in the vertical direction with respect to a main surface of the phased array antenna, and has an opening on a main surface opposite to the main surface.

Further, according to Claim 8 of the present invention, in the phased array antenna defined in Claim 7, the feeding phase shift unit includes one propagation characteristic variable line in the variable dielectric-constant dielectric layer, and at least a pair of the openings are formed at positions which are opposed to each other with respect to the center of the propagation characteristic variable line.

Further, according to Claim 9 of the present invention, in the phased array antenna defined in Claim 7, the feeding phase shift unit includes plural propagation characteristic variable lines in the variable dielectric-constant dielectric layer, and at least a pair of the openings are formed opposed to each other at positions outside the plural propagation characteristic variable lines.

Further, according to Claim 10 of the present invention, in the phased array antenna defined in any of Claims 7 to 9, the opening is provided in the variable dielectric-constant dielectric layer outside an arc having a radius which corresponds to a straight line connecting the center of the propagation characteristic variable line and the propagation characteristic variable line end.

Further, according to Claim 11 of the present invention, in the phased array antenna defined in any of Claims 7 to 9, the opening is provided at a position within the variable dielectric-constant dielectric layer, which position is apart from the propagation characteristic variable line by a distance at least three times as long as a distance corresponding to the wavelength of the electromagnetic wave that propagates in the propagation characteristic variable line.

Further, according to Claim 12 of the present invention, in the phased array antenna defined in any of Claims 7 to 9, the variable dielectric-constant dielectric layer comprises a liquid crystal or a material including a liquid crystal.

Further, according to Claim 13 of the present invention, in the phased array antenna defined in Claim 12, the variable dielectric-constant dielectric layer is formed by injecting a liquid crystal or a material including a liquid crystal via the opening.

### Effects of the Invention

According to the present invention, when a phased array antenna having variable phase shifters constituted by using a variable dielectric-constant dielectric substance whose dielectric constant varies according to an applied electric field is constituted such that a group of the variable phase shifters for right-side tilt and a group of the variable phase shifters for left-side tilt can be controlled for their phase shift amounts independently from each other in order to realize a high directional gain, a DC blocking element for dc-wise separating two bias voltages, which causes mismatching, can be dispensed with, thereby realizing an antenna which can maintain a high directional gain with less deformation of the beam shape even when beam tilt occurs.

Further, according to the present invention, in a phased array antenna having variable phase shifters constituted by using a variable dielectric-constant dielectric substance whose dielectric constant varies according to an applied voltage, since a liquid crystal or a complex material including a liquid crystal is injected as a variable dielectric-constant dielectric layer constituting each variable phase shifter of the phased array antenna by a vacuum injection method or a capillary injection method, the liquid crystal or the complex material including a liquid crystal can be uniformly injected into a liquid crystal container to be the variable dielectric-constant dielectric layer, thereby realizing a phased array antenna which can reduce variations in the dielectric constant of the variable dielectric-constant dielectric layer, and maintain a high directional gain with less deformation of the beam shape even when beam tilt occurs.

### BRIEF DESCRIPTION OF THE DRAWINGS

FIG. 1(a) is a diagram illustrating a plan view and cross-sectional views of a phased array antenna according to a first embodiment of the present invention.

FIG. 1(b) is a diagram illustrating plan views of the respective conductor layers in the phased array antenna according to the first embodiment of the present invention.

FIG. 1(c) is a diagram illustrating electric field distributions in the vicinity of a main conductor layer and a sub conductor layer in the phased array antenna according to the first embodiment of the present invention.

FIG. 2(a) is a diagram illustrating a plan view and cross-sectional views of a phased array antenna according to a second embodiment of the present invention.

FIG. 2(b) is a diagram illustrating electric field distributions in the vicinity of a main conductor layer and a sub conductor layer in the phased array antenna according to the second embodiment of the present invention.

FIG. 3 is a diagram illustrating an example of characteristics of a variable dielectric-constant dielectric layer.

FIG. 4 is a diagram illustrating the principle of a phase shifter.

FIG. 5 is a diagram illustrating the principle of a phased array antenna.

FIG. 6 is a diagram illustrating a layout of phase shifters in a high-gain phased array antenna.

FIG. 7(a) is a diagram illustrating a plan view and cross-sectional views of a conventional phased array antenna disclosed in Patent Document 2.

FIG. 8(a) is a diagram illustrating a plan view and cross-sectional views of a conventional phased array antenna disclosed in Claim 1 of Patent Document 1.

FIG. 8(b) is a diagram illustrating plan views of the respective conductor layers in the conventional phased array antenna disclosed in Claim 1 of Patent Document 1.

FIG. 9(a) is a diagram illustrating a plan view and cross-sectional views of a conventional phased array antenna disclosed in Claim 2 of Patent Document 1.

FIG. 9(b) is a diagram illustrating plan views of the respective conductor layers in the conventional phased array antenna disclosed in Claim 2 of Patent Document 1.

FIG. 10 is a plan view of a phased array antenna according to a third embodiment of the present invention.

FIG. 11 is a plan view of a variable phase shifter according to the third embodiment of the present invention.

FIG. 12 is a plan view of a variable phase shifter having a liquid crystal injection hole for each propagation characteristic variable line according to a fourth embodiment of the present invention.

FIG. 13 is a cross-sectional view illustrating the overall outline of the phased array antenna according to the third embodiment of the present invention.

FIG. 14 is a diagram illustrating cross-sectional views taken along lines shown in FIG. 11 according to the third embodiment of the present invention.

FIG. 15 is a diagram illustrating cross-sectional views for explaining a method for fabricating the phased array antenna according to the third embodiment of the present invention.

FIG. 16 is a plan view of a variable phase shifter according to a fifth embodiment of the present invention.

FIG. 17 is a diagram illustrating another example of a variable phase shifter according to the fifth embodiment of the present invention.

FIG. 18 is a diagram illustrating still another example of a variable phase shifter according to the fifth embodiment of the present invention.

FIG. 19 is a diagram for explaining the operation principle of a variable phase shifter.

### DESCRIPTION OF THE REFERENCE NUMERALS

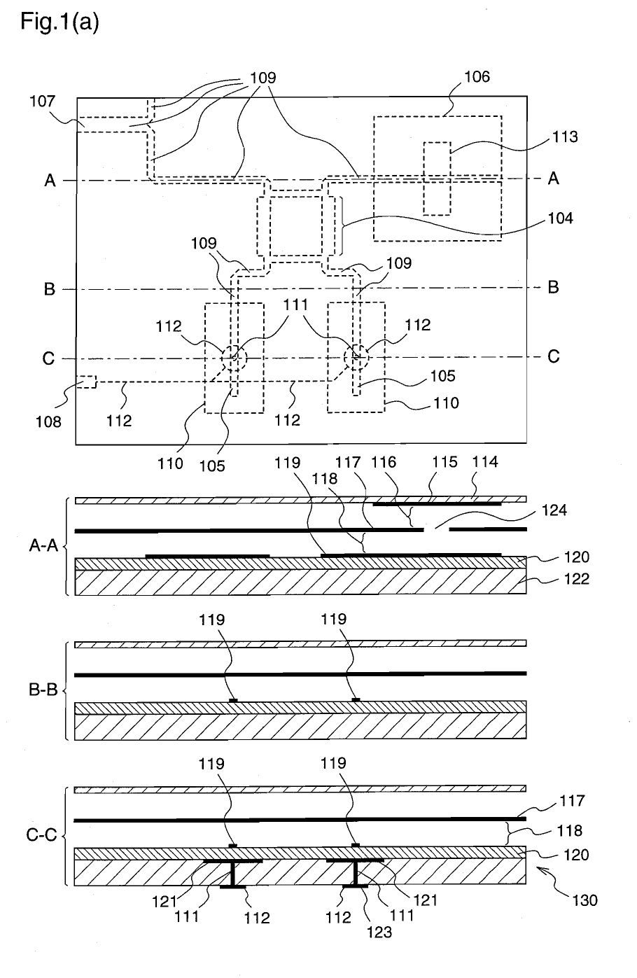

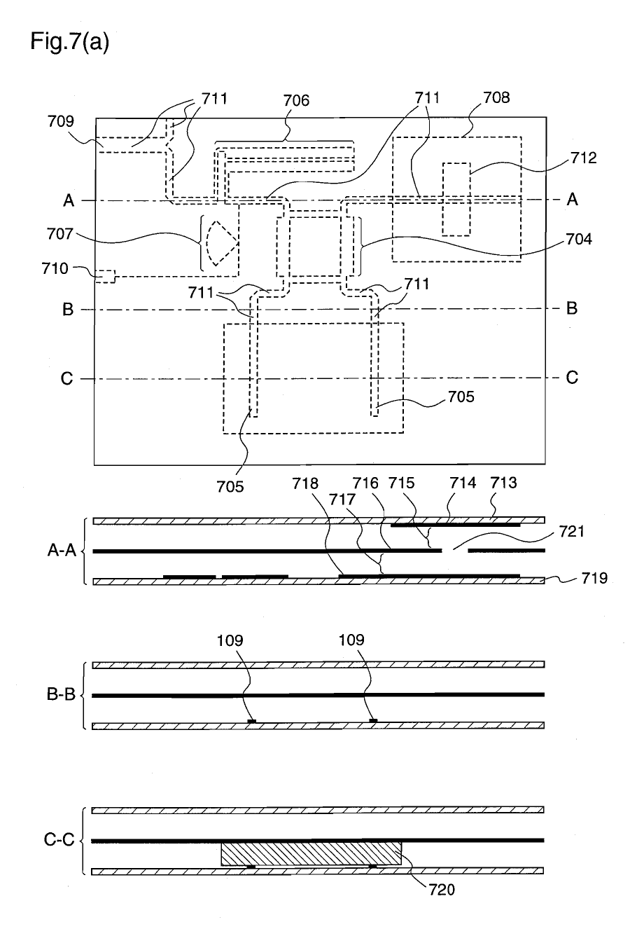

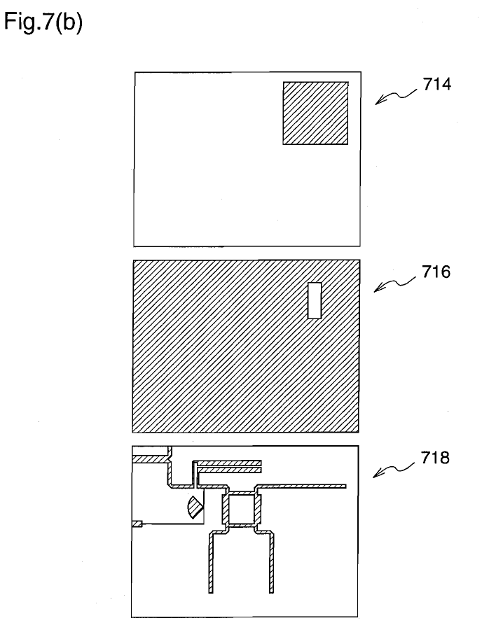

104 . . . hybrid coupler
105 . . . propagation characteristic variable line
106 . . . antenna element
107 . . . input terminal
108 . . . bias terminal
109 . . . feeding line
110 . . . bias line
111 . . . bias voltage supply through-hole
112 . . . through-hole land
113 . . . binding window
114 . . . insulator layer
115 . . . conductor layer
116 . . . air layer for insulator
117 . . . ground conductor layer
118 . . . air layer for insulator
119 . . . main conductor layer
120 . . . variable dielectric-constant dielectric layer
121 . . . sub conductor layer
122 . . . insulator layer
123 . . . conductor layer
124 . . . binding window
125 . . . electric field created by high-frequency power propagating on main conductor layer
126 . . . electric field created by high-frequency power propagating on main conductor layer and sub conductor layer
130 . . . feeding phase shift unit
204 . . . hybrid coupler
205 . . . propagation characteristic variable line
206 . . . antenna element
207 . . . input terminal
208 . . . bias terminal
209 . . . feeding line
210 . . . bias line
211 . . . bias voltage supply through-hole
212 . . . through-hole land
213 . . . binding window
214 . . . insulator layer
215 . . . conductor layer
216 . . . air layer for insulator
217 . . . ground conductor layer
218 . . . insulator layer
219 . . . main conductor layer
220 . . . variable dielectric-constant dielectric layer
221 . . . sub conductor layer
222 . . . insulator layer
223 . . . conductor layer
224 . . . binding window
225 . . . electric field created by high-frequency power propagating on main conductor layer
226 . . . electric field created by high-frequency power propagating on main conductor layer and sub conductor layer
230 . . . feeding phase shift unit
240 . . . spacer
250 . . . space
401 . . . waveguide ground conductor
402 . . . waveguide insulator
403 . . . I/O line
404 . . . hybrid coupler
405 . . . front end open line
406 . . . waveguide insulator of front end open line
500 . . . feeding phase shift unit
501 to 504 . . . antenna element
505 to 508 . . . variable phase shifter
509 feeding terminal
510 . . . bias voltage
600 feeding phase shift unit
601 . . . feeding terminal
602 . . . variable phase shifters for right-side tilt
603 . . . variable phase shifters for left-side tilt
604 . . . bias voltage for right-side tilt
605 . . . bias voltage for left-side tilt
606 . . . antenna element
607 . . . DC blocking element
608 . . . high frequency blocking element
609 . . . areas extracted to FIGS. 1, 2, 7, 8, and 9
704 . . . hybrid coupler
705 . . . propagation characteristic variable line
706 . . . DC blocking element
707 . . . high frequency blocking element
708 . . . antenna element
709 . . . input terminal
710 . . . bias terminal
711 . . . feeding line
712 . . . binding window
713 . . . insulator layer
714 . . . conductor layer
715 . . . air layer for insulator
716 . . . ground conductor layer
717 . . . air layer for insulator
718 . . . conductor layer
719 . . . insulator layer
720 . . . variable dielectric-constant dielectric layer
721 . . . binding layer
804 . . . hybrid coupler
805 . . . propagation characteristic variable line
806 . . . DC blocking element
807 . . . high frequency blocking element
808 . . . antenna element
809 . . . input terminal
810 . . . bias terminal
811 . . . feeding line
812 . . . binding window
813 . . . through-hole
814 . . . insulator layer
815 . . . conductor layer
816 . . . air layer for insulator
817 . . . ground conductor layer
818 . . . air layer
819 . . . conductor layer
820 . . . dielectric layer for insulator
821 . . . ground conductor layer
822 . . . variable dielectric-constant dielectric layer
823 . . . conductor layer
824 . . . binding window
825 . . . through-hole
904 . . . hybrid coupler
905 . . . propagation characteristic variable line
906 . . . antenna element
907 . . . input terminal
908 . . . bias terminal
909 . . . feeding line
910 . . . binding window
911 . . . DC blocking element
912 . . . binding window
913 . . . high frequency blocking element
914 . . . insulator layer
915 . . . conductor layer
916 . . . air layer for insulator
917 . . . ground conductor layer
918 . . . air layer
919 . . . conductor layer
920 . . . dielectric layer
921 . . . ground conductor layer
922 . . . variable dielectric-constant dielectric layer
923 . . . conductor layer
924 . . . binding window
925 . . . DC blocking element
926 . . . binding window
110 . . . input terminal
111 . . . feeding line
112 . . . hybrid coupler
113 . . . antenna element
114 . . . binding window
115 . . . propagation characteristic variable line
116 . . . bias voltage supply through-hole
117 . . . through-hole land
118 . . . sub conductor (bias electrode plane)
119 . . . bias line
120 . . . bias terminal
121 . . . variable dielectric-constant dielectric layer
122 . . . opening
123 . . . second opening
124 . . . propagation characteristic variable line end
130 . . . first insulator layer
131 . . . conductor layer (antenna element)
132 . . . binding window
133 . . . second insulator layer
134 . . . ground conductor layer
135 . . . propagation characteristic fixed line
136 . . . third insulator layer
137 . . . propagation characteristic variable line
138 . . . variable dielectric-constant dielectric layer
139 . . . sub conductor layer (bias line)
140 . . . bias voltage supply through-hole
141 . . . through-hole land
142 . . . plane of second insulator layer contacting variable dielectric-constant dielectric layer
143 . . . plane of third insulator layer contacting variable dielectric-constant dielectric layer
144 . . . open hole
215 . . . propagation characteristic variable line
250 . . . center of first opening
251 . . . center of second opening
260 . . . first propagation characteristic variable line end
261 . . . second propagation characteristic variable line end
262 . . . third propagation characteristic variable line end
263 . . . fourth propagation characteristic variable line end
270 . . . straight line connecting center 250 of first opening and intersection point 260
271 . . . straight line connecting center 250 of first opening and intersection point 261
272 . . . straight line connecting center 250 of first opening and intersection point 262
273 . . . straight line connecting center 250 of first opening and intersection point 263
280 . . . straight line connecting center 250 of first opening 122 and center 251 of second opening 123
281 . . . arc curve in variable dielectric-constant dielectric layer 121, having radius corresponding to line connecting center 250 of first opening 122 and intersection point 263
301 . . . feeding port
302 . . . first variable phase shifter
303 . . . second variable phase shifter
304 . . . antenna patch
305 . . . opening (injection port)
306 . . . assembly of variable phase shifters
307 . . . high-frequency circuit
308 . . . feeding phase shift unit
309 . . . antenna unit
310 . . . connection line
401 . . . waveguide ground conductor
402 . . . waveguide insulator
403 . . . I/O line
404 . . . hybrid coupler
405 . . . front end open line
406 . . . waveguide insulator of front end open line

### BEST MODE TO EXECUTE THE INVENTION

Hereinafter, embodiments of phased array antennas according to the present invention will be described in detail with reference to the drawings.

### Embodiment 1

Initially, a description will be given of an embodiment of a phased array antenna of the present invention which adopts a solid dielectric material as a variable dielectric-constant dielectric layer.

FIG. 1(a) illustrates a plan view and cross-sectional views of a phased array antenna according to the first embodiment of the present invention.

In FIG. 1(a), a diagram positioned at the top is a plan view of the antenna viewed from the radiation plane side. Subsequently, a A-A cross-sectional view, a B-B cross-sectional view, and a C-C cross-sectional view showing the states of cross sections obtained when the antenna is cut along a A-A line, a B-B line, and a C-C line in the plan view, respectively, are illustrated toward the bottom in the figure.

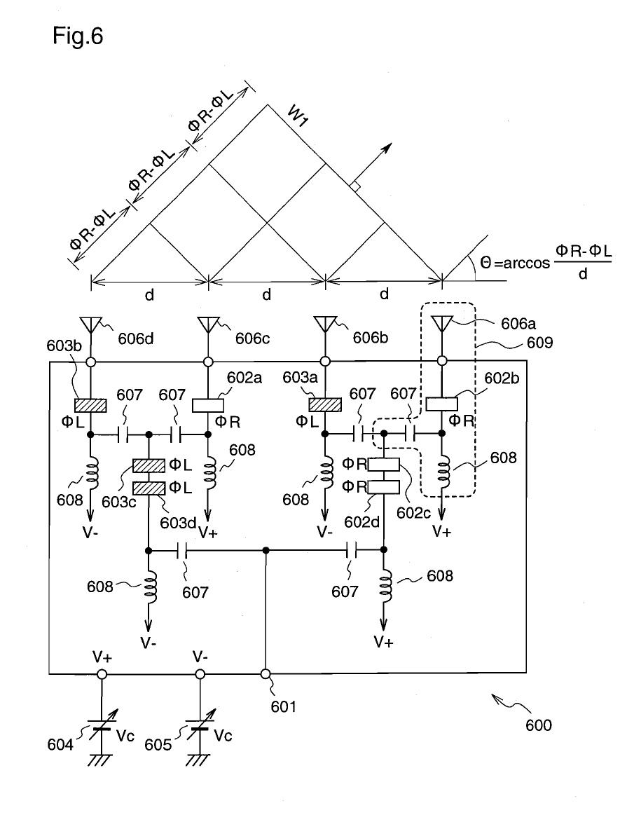

The display area of the plan view is identical to that of the conventional antenna shown in FIG. 7.

Further, in the plan view, a pattern of a hybrid coupler 104 and a pattern of a propagation characteristic variable line 105 are illustrated by broken lines.

Further, in the plan view, 106 denotes an antenna element, 107 denotes an input terminal, 108 denotes a bias terminal, 109 denotes a feeding line pattern, 110 denotes a bias line, 111 denotes a bias voltage supply through-hole, 112 denotes a land for through-hole, and 113 denotes a binding window which electromagnetically combines the feeding line pattern 109 with the antenna element 106. These areas as well as the area of the hybrid coupler 104 constitute a propagation characteristic fixed line whose propagation characteristics against a high frequency do not vary even when a bias voltage is applied.

On the other hand, a layer structure constituting the antenna and constituents thereof are shown in the A-A cross-sectional view, the B-B cross-sectional view, and the C-C cross-sectional view in FIG. 1(a).

In these A-A cross-sectional view, B-B cross-sectional view, and C-C cross-sectional view, 114 to 117 are constituents of a plane waveguide structure which constitutes an antenna unit, and more specifically, 114 denotes an insulator layer for supporting an antenna element, 115 denotes a conductor layer constituting the antenna element, 116 denotes an air layer as an insulator layer required for constituting the plane waveguide structure, and 117 denotes a ground conductor layer required for constituting the plane waveguide structure.

Further, 117 to 123 are constituents of a plane waveguide structure which constitutes a feeding phase shift unit 130, and 117 denotes a ground conductor layer required for constituting the plane waveguide structure, and it is shared with the antenna unit. Further, 118 denotes an air layer as an insulator layer required for constituting the plane waveguide structure, 119 denotes a main conductor layer constituting the respective patterns of the feeding phase shift unit, 120 denotes a variable dielectric-constant dielectric layer for a propagation characteristic variable line, 121 denotes a sub conductor layer constituting a bias line for varying the electric field distribution state of the propagation characteristic variable line, 122 denotes an insulator layer for electromagnetically isolating a bias voltage supply circuit from the main conductor layer 119, and 123 denotes a conductor layer forming a wiring pattern of the bias voltage supply circuit.

As for the five conductor layers including the conductor layer 115, the ground conductor layer 117, the main conductor layer 119, the sub conductor layer 121, and the conductor layer 123, the respective layers are independently shown in FIG. 1(b) so that the pattern configurations of the respective layers can be easily understood.

In the phased array antenna according to the first embodiment which is constituted as described above, as shown in the A-A cross-sectional view, the B-B cross-sectional view, and the C-C cross-sectional view, a first inverted type (also known as suspended type) microstrip structure for the antenna unit is constituted by the four layers including the insulator layer 114, the conductor layer 115, the air layer 116, and the ground conductor layer 117, while a second inverted type microstrip structure for the feeding phase shift unit is constituted by the four layers including the ground conductor layer 117, the air layer 118, the main conductor layer 119, and the variable dielectric-constant dielectric layer 120. The second inverted type microstrip structure is further provided with the three layers including the sub conductor layer 121, the insulator layer 122, and the conductor layer 123 on the side opposite to the ground conductor layer 117 and the main conductor layer 119 (the lower side in the C-C cross-sectional view), thereby providing an improved type line.

As described above, the phased array antenna according to the first embodiment is provided with the feeding phase shift unit having the laminated structure obtained by laminating at least the ground conductor layer 117, the insulator layer 118 as an air layer, the main conductor layer 119, the variable dielectric-constant dielectric layer 120, and the sub conductor layer 121 in this order.

Further, as shown in the plan view of FIG. 1(a), the antenna element 106 (115 in the A-A cross-sectional view) and the feeding line pattern 109 (119 in the B-B cross-sectional view) are electromagnetically combined with each other via the binding window 113 (the binding window 124 in the A-A cross-sectional view) which is formed on the ground conductor layer 117 that is shared by the antenna unit and the feeding phase shift unit, and exchange the high-frequency power.

Further, by applying a bias voltage between the bias terminal 108 formed on the conductor layer 123, and the main conductor layer and the ground conductor layer 117 (the main conductor layer 119 and the ground conductor layer 117 are at the same potential), this bias voltage is applied to the bias line 110 via the through-hole land 112 and the bias voltage supply through-hole 111.

As described above, in the feeding phase shift unit (117 to 123) in the phased array antenna according to the first embodiment, the propagation characteristic fixed lines 104 and 109 for propagating the high-frequency power without varying its propagation characteristics and the propagation characteristic variable line 105 which propagates the high-frequency power with the propagation characteristics according to the bias voltage are provided on the main conductor layer 119 as the continuous conductors, and no bias line is provided on the sub conductor layer 121 in the area where the propagation characteristic fixed lines 104 and 109 are formed, while the bias line 110 is provided on the sub conductor layer 121 in the area where the propagation characteristic variable line 105 is formed.

Hereinafter, the operations of the propagation characteristic fixed lines and the propagation characteristic variable line will be described in more detail with reference to FIG. 1(c) obtained by enlarging the periphery of the main conductor in the B-B cross-sectional view and the C-C cross-sectional view.

FIG. 1(c) shows the main conductor layer 119 in the B-B cross-sectional view, and the electric field distribution of the high frequency power that propagates on the main conductor layer 119 and the sub conductor layer 121 in the B-B cross-sectional view.

In FIG. 1(c), 117 denotes a ground conductor layer, 118 denotes an air layer as an insulator, 120 denotes a variable dielectric-constant dielectric layer, and 122 denotes an insulator layer.

Further, 125 denotes an electric field generated by the high-frequency power that propagates on the main conductor layer in the B-B cross-sectional view, and 126 denotes an electric field generated by the high-frequency power that propagates on the main conductor layer and the sub conductor layer in the C-C cross-sectional view.

As shown in FIG. 1(c), in the B-B cross-sectional view, no bias line is provided on the sub conductor layer in the area that planarly overlaps with the line disposed on the main conductor layer, and therefore, the electric flux lines outputted from the main conductor layer hardly pass through the variable dielectric-constant dielectric layer but are concentrated to between the main conductor layer and the ground conductor layer.

Accordingly, when a bias voltage is applied to the phase shifter, no electric field is caused by the bias voltage in the variable dielectric-constant dielectric layer in the vicinity of the main conductor layer, and therefore, the dielectric constant of the variable dielectric-constant dielectric layer does not vary, and also the propagation characteristics against the high-frequency power that propagates on the main conductor do not vary, whereby the main conductor in this area constitutes the propagation characteristic fixed line.

On the other hand, in the C-C cross-sectional view shown in FIG. 1(c), since the bias line is provided on the sub conductor layer in the area which planarly overlaps with the line provided on the main conductor layer, the electric flux lines outputted from the main conductor layer are distributed and propagated to not only between the main conductor layer and the ground conductor layer but also between the main conductor layer and the sub conductor layer. Many of the distributed and propagated electric flux lines pass through the variable dielectric-constant dielectric layer.

Therefore, when a bias voltage is applied to the phase shifter, an electric field due to the bias voltage is generated between the main conductor layer and the bias line. Since this electric field caused by the bias voltage and the electric field component 126 generated by the high-frequency power distributed between the main conductor layer and the sub conductor layer are approximately parallel to each other, the dielectric constant of the variable dielectric-constant dielectric layer between the main conductor layer and the bias line varies and thereby the propagation characteristics against the high-frequency power that propagates on the main conductor layer also vary, and therefore, the main conductor layer in this area constitutes the propagation characteristic variable line.

That is, in the phased array antenna of the first embodiment, the dielectric constant of the variable dielectric-constant dielectric layer in the propagation characteristic variable line is varied by varying the bias voltage applied between the main conductor layer and the sub conductor layer, and thereby the propagation characteristics of the propagation characteristic variable line are varied to control the phase shift amount.

Further, since the variable dielectric-constant dielectric layer is inserted between the main conductor layer and the sub conductor layer in the propagation characteristic fixed line, no DC voltage is applied between the main conductor layer and the sub conductor layer even when a bias voltage is applied between the ground conductor layer and the sub conductor layer. Therefore, the control voltage for right-side tilt and the control voltage for left-side tilt do not collide with each other via the main conductor layer, resulting in a construction that requires no current blocking element.

As described above, according to the phased array antenna of the first embodiment, since the feeding phase shift unit has the laminated structure which is formed by laminating the ground conductor layer, the insulator layer, the main conductor layer, the variable dielectric-constant dielectric layer, and the sub conductor layer in this order, it is possible to isolate the line through which the high-frequency power propagates from the basis voltage, without providing a DC blocking element on the line. Accordingly, when the phased array antenna is constituted such that the variable phase shifters are divided into the variable phase shifters for right-side tilt and the variable phase shifters for left-side tilt and the phase shift amounts thereof are independently controlled to realize a high directional gain, accumulation of mismatches due to a DC blocking element is avoided, thereby realizing an antenna which can maintain a high directional gain, with less deformation of the beam shape even when beam tilt occurs.

Further, in the plan view shown in FIG. 1(a), the phased array antenna of the first embodiment is not provided with a line pattern corresponding to the high frequency blocking element disclosed in Patent Document 2 and Patent Document 1. The reason is as follows. Since a greater part of the high frequency current that flows on the bias line 110 concentrates on the surface that faces the main conductor layer 119, such high frequency blocking element can be dispensed with by adopting the laminated structure to which power is supplied from the side opposite to the main conductor layer 119 as shown in FIG. 1.

In this first embodiment, a ferroelectric material such as BaTiO₃ or BaSrTiO₃—MgO can be used as the variable dielectric-constant dielectric layer.

Further, while an air layer is adopted as the insulator layer, the insulator layer may be a layer comprising thermoset epoxy resin, urethane resin, xylene resin, or UV-curable acrylic resin, epoxy resin, phenol resin, or a resin such as polytetrafluoroethylene (PTFE), liquid crystal polymer, polyimide, polyamide, epoxy, or a complex material thereof, or a glass, ceramics, photo-polymerized polymer, heat-polymerized polymer.

### Embodiment 2

Next, a description will be given of an embodiment of a phased array antenna of the present invention which adopts a liquid dielectric material such as a liquid crystal for a variable dielectric-constant dielectric layer.

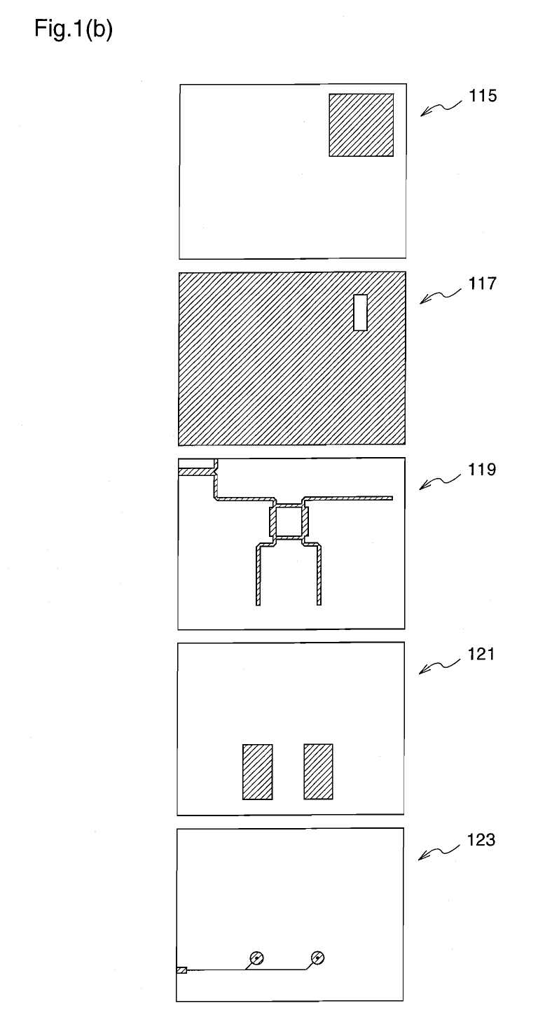

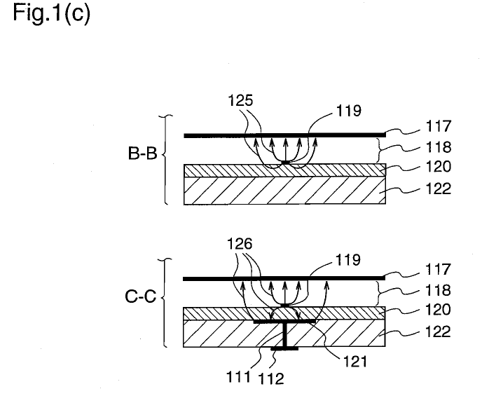

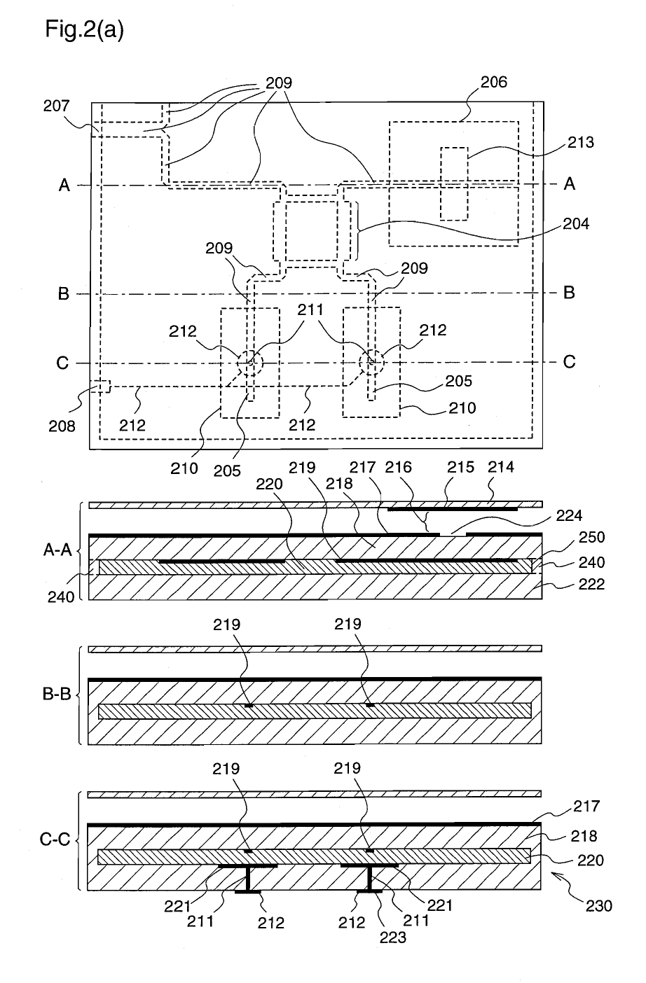

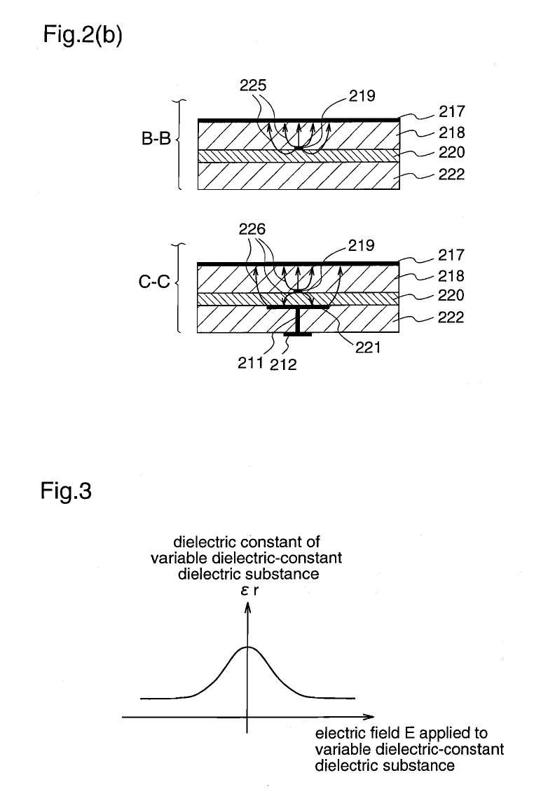

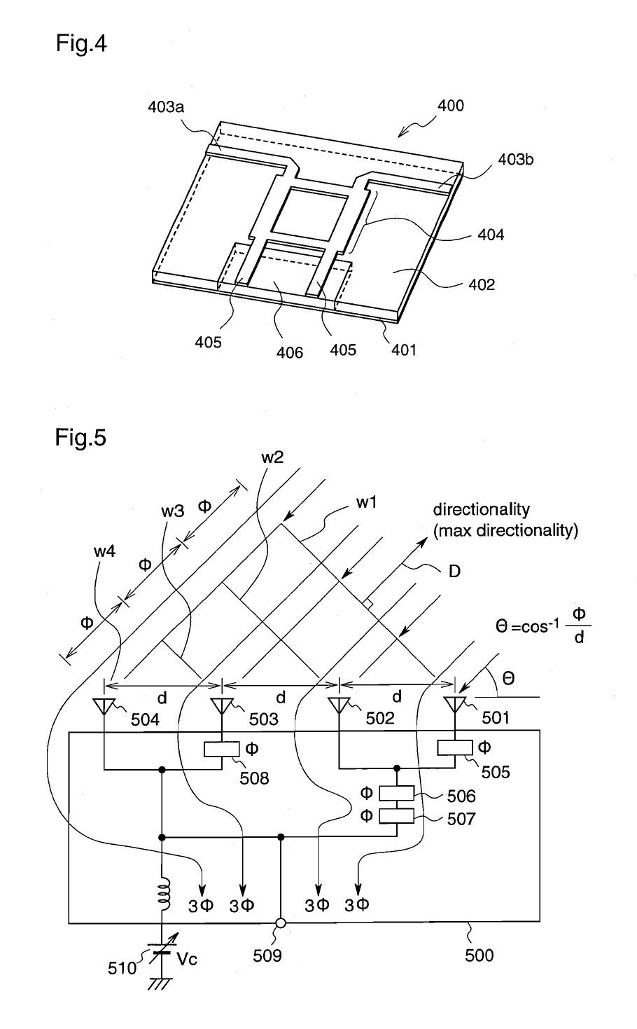

FIG. 2(a) illustrates a plan view and cross-sectional views of a phased array antenna according to the second embodiment of the present invention.

In FIG. 2(a), a diagram positioned at the top is a plan view of the antenna viewed from the radiation plane side. Subsequently, a A-A cross-sectional view, a B-B cross-sectional view, and a C-C cross-sectional view showing the states of cross sections obtained when the antenna is cut along a A-A line, a B-B line, and a C-C line in the plan view, respectively, are illustrated toward the bottom in the figure.

The display area of the plan view is identical to that of the conventional antenna shown in FIG. 7.

Further, in the plan view, a pattern of a hybrid coupler 204 and a pattern of a propagation characteristic variable line 205 are illustrated by broken lines.

Further, the respective elements 206 to 210 shown in the plan view are identical to those of the first embodiment shown in FIG. 1.

On the other than, a layer structure constituting the antenna and its constituents are shown in the A-A cross-sectional view, the B-B cross-sectional view, and the C-C cross-sectional view.

In the A-A cross-sectional view, B-B cross-sectional view, and C-C cross-sectional view, 214 to 217 are constituents of a plane waveguide structure which constitutes an antenna unit, and this antenna unit is identical to that of the first embodiment shown in FIG. 1.

Further, 217 to 223 are constituents of a plane waveguide structure which constitutes a feeding phase shift unit 230, and 217 denotes a ground conductor layer required for constituting the plane waveguide structure, and it is shared with the antenna unit. Further, 218 denotes an insulator layer required for constituting the plane waveguide structure, 219 denotes a main conductor layer constituting the respective patterns of the feeding phase shift unit, 220 denotes a variable dielectric-constant dielectric layer for a propagation characteristic variable line, 221 denotes a sub conductor layer constituting a bias line for varying the electric field distribution state of the propagation characteristic variable line, 222 denotes an insulator layer for electromagnetically isolating a bias voltage supply circuit from the main conductor layer 219, and 223 denotes a conductor layer constituting a wiring pattern of the bias voltage supply circuit.

In this second embodiment, a liquid such as a liquid crystal is used as the variable dielectric-constant dielectric layer 220. The two insulator layers 218 and 222 are connected to each other at their end portions by spacers 240 comprising the same material as the insulator layers 218 and 222 to constitute a box configuration which encloses the liquid at the ends of the antenna and holds the liquid as shown in the A-A cross-sectional view, B-B cross-sectional view, and C-C cross-sectional view, whereby the variable dielectric-constant dielectric layer 220 as a liquid dielectric substance such as a liquid crystal is stably held (stored) in a hermetically-sealed space 250 in the box-shaped insulator layer.

Further, since the main conductor layer 219 cannot be formed on the liquid, it is formed on the surface of the insulator layer 218.

The five conductor layers 215, 217, 219, 221, and 223 are identical to those of the first embodiment, and the pattern configurations of the respective layers are identical to those shown in FIG. 1(b).

In the phased array antenna according to the second embodiment which is constituted as described above, as shown in the A-A cross-sectional view, the B-B cross-sectional view, and the C-C cross-sectional view, a first inverted type (also known as suspended type) microstrip structure for the antenna unit is constituted by the four layers including the insulator layer 214, the conductor layer 215, the air layer 216, and the ground conductor layer 217, while a second inverted type microstrip structure for the feeding phase shift unit is constituted by the four layers including the ground conductor layer 217, the insulator layer 218, the main conductor layer 219, and the variable dielectric-constant dielectric layer 220. The second inverted type microstrip structure is further provided with the three layers including the sub conductor layer 221, the insulator layer 222, and the conductor layer 223 on the side opposite to the ground conductor layer 217 and the main conductor layer 219 (the lower side in the C-C cross-sectional view), thereby providing an improved type line.

Hereinafter, the operations of the propagation characteristic fixed line and the propagation characteristic variable line will be described in more detail with reference to FIG. 2(b) obtained by enlarging the periphery of the main conductor in the B-B cross-sectional view and the C-C cross-sectional view.

FIG. 2(b) shows the electric field distributions of the high frequency power that propagates on the main conductor layer 219 in the B-B cross-sectional view, and on the main conductor layer 219 and the sub conductor layer 221 in the B-B cross-sectional view, respectively.

Further, in FIG. 2(b), 217 denotes a ground conductor layer, 218 denotes an insulator layer, 220 denotes a variable dielectric-constant dielectric layer, and 222 denotes an insulator layer.

Further, 225 denotes an electric field generated by the high-frequency power that propagates on the main conductor layer 219 in the B-B cross-sectional view, and 226 denotes an electric field generated by the high-frequency power that propagates on the main conductor layer 219 and the sub conductor layer 221 in the C-C cross-sectional view.

As shown in FIG. 2(b), since, in region of the B-B cross-sectional view, no bias line is provided on the sub conductor layer in the area which planarly overlaps with the line disposed on the main conductor layer, the electric flux lines outputted from the main conductor layer hardly pass through the variable dielectric-constant dielectric layer, but are concentrated to between the main conductor layer and the ground conductor layer.

Accordingly, when a bias voltage is applied to the phase shifter, no electric field is caused by the bias voltage in the variable dielectric-constant dielectric layer in the vicinity of the main conductor layer, and thereby the dielectric constant of the variable dielectric-constant dielectric layer does not vary, and also the propagation characteristics against the high-frequency power that propagates on the main conductor layer do not vary, whereby the main conductor layer in this area constitutes the propagation characteristic fixed line.

On the other hand, in the C-C cross-sectional view shown in FIG. 2(b), since the bias line is provided on the sub conductor layer in the area which planarly overlaps with the line provided on the main conductor layer, the electric flux lines outputted from the main conductor layer are distributed and propagated not only between the main conductor layer and the ground conductor layer but also between the main conductor layer and the sub conductor layer. Many of the distributed and propagated electric flux lines pass through the variable dielectric-constant dielectric layer.

Therefore, when a bias voltage is applied to the phase shifter, an electric field due to the bias voltage is generated between the main conductor layer and the bias line. Since this electric field caused by the bias voltage and the electric field component 226 generated by the high-frequency power distributed between the main conductor layer 219 and the sub conductor layer are approximately parallel to each other, the dielectric constant of the variable dielectric-constant dielectric layer between the main conductor layer and the bias line varies and thereby the propagation characteristics against the high-frequency power that propagates on the main conductor layer also vary, and therefore, the main conductor layer in this area constitutes the propagation characteristic variable line.

That is, in the phased array antenna of the second embodiment, the dielectric constant of the variable dielectric-constant dielectric layer in the propagation characteristic variable line is varied by varying the bias voltage applied to between the main conductor layer and the sub conductor layer, and thereby the propagation characteristics of the propagation characteristic variable line are varied to control the phase shift amount.

Further, since the variable dielectric-constant dielectric layer is inserted between the main conductor layer and the sub conductor layer in the propagation characteristic fixed line, no DC voltage is directly applied to the main conductor layer even when a bias voltage is applied to the sub conductor layer. Therefore, the control voltage for right-side tilt and the control voltage for left-side tilt never collide via the main conductor layer, resulting in a construction which requires no current blocking element.

As described above, according to the second embodiment, since the feeding phase shift unit has the laminated structure which is formed by laminating the ground conductor layer, the insulator layer, the main conductor layer, the variable dielectric-constant dielectric layer, and the sub conductor layer in this order, it is possible to isolate the bias voltage from the line through which the high-frequency power propagates without providing a DC blocking element on this line. Accordingly, when the phased array antenna is constituted such that the variable phase shifters are divided into the variable phase shifters for right-side tilt and the variable phase shifters for left-side tilt and the phase shift amounts thereof are independently controlled to realize a high directional gain, accumulation of mismatches due to a DC blocking element is avoided, thereby realizing a phased array antenna which can maintain a high directional gain, with less deformation of the beam shape even when beam tilt occurs.

Further, according to the second embodiment, since a liquid crystal is used as the variable dielectric-constant dielectric layer, it is possible to realize a phased array antenna in which the dielectric constant of the variable dielectric-constant dielectric layer can be easily varied.

In this second embodiment, a nematic liquid crystal, a smectic liquid crystal, a cholesteric liquid crystal, a discotic liquid crystal, or a ferroelectric liquid crystal, or a complex material comprising a liquid crystal and a resin can be used as a liquid-state variable dielectric-constant dielectric layer.

While in this second embodiment the individual insulator layers 218 and 222 and the spacers 240 are connected to form the box-shaped insulator layer having the space 250 in which the variable dielectric-constant dielectric layer 22 is stored, the box-shaped insulator layer may be formed in one body so long as it can stably hold the liquid-state variable dielectric-constant dielectric layer 220.

Further, a structure other than that of the second embodiment may be adopted so long as it can stably hold the liquid-state variable dielectric-constant dielectric layer 220.

Furthermore, the box-shaped variable dielectric-constant dielectric layer of the second embodiment in which the liquid crystal is stably stored can be used as the variable dielectric-constant dielectric layer of the first embodiment. In this case, two merits are obtained, i.e., air having extremely small dielectric loss can be used as an insulator layer for the main conductor layer, and a liquid crystal can be used as a variable dielectric-constant dielectric substance and thereby the range of choice for the variable dielectric-constant dielectric material is increased.

Further, in the first and second embodiments, the line configuration of the main conductor layer or the sub conductor layer in the propagation characteristic variable line may be a linear resonator line configuration having a length of 1/2 wavelength or an integer multiple thereof, or a ring or disk type resonator line configuration, and also in these cases, the above-described propagation characteristic variable characteristics can be similarly obtained.

Further, in this second embodiment, in order to prevent the conductor metals of the main conductor layer and the sub conductor layer from directly contacting the liquid crystal, buffer layers may be disposed on the surfaces of the both conductor layers.

### Embodiment 3

Next, a description will be given of an embodiment of a phased array antenna of the present invention which is constituted by providing a phased array antenna having a laminated layer structure, and then forming a variable dielectric-constant dielectric layer by uniformly injecting a liquid crystal or a material containing a liquid crystal into the structure.

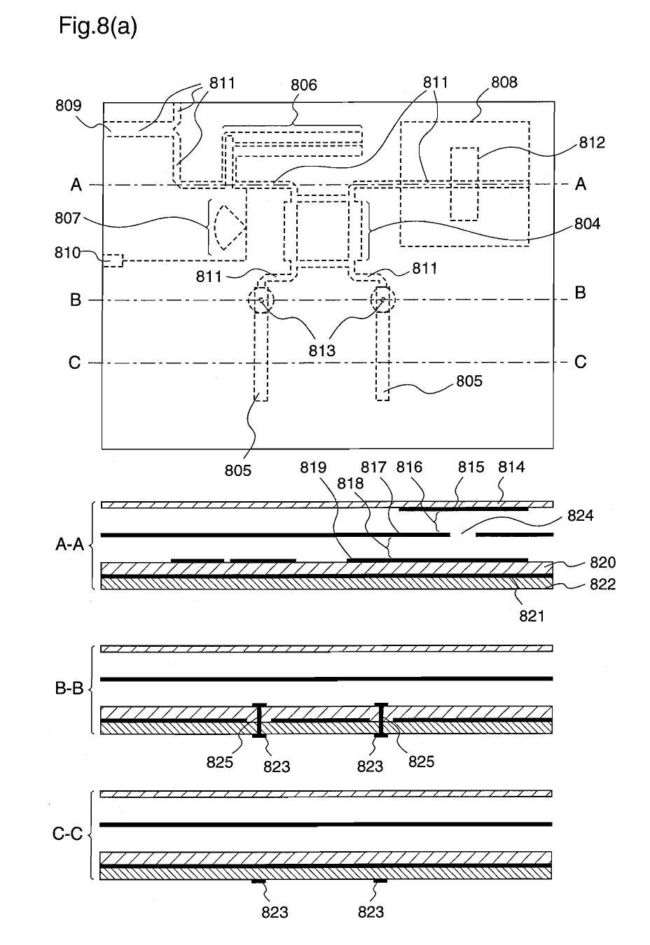

FIG. 10 is a plan view illustrating an example of a phased array antenna according to a third embodiment of the present invention. In FIG. 10, the phased array antenna comprises a laminated structure of a feeding phase shift unit 308 and an antenna unit 309.

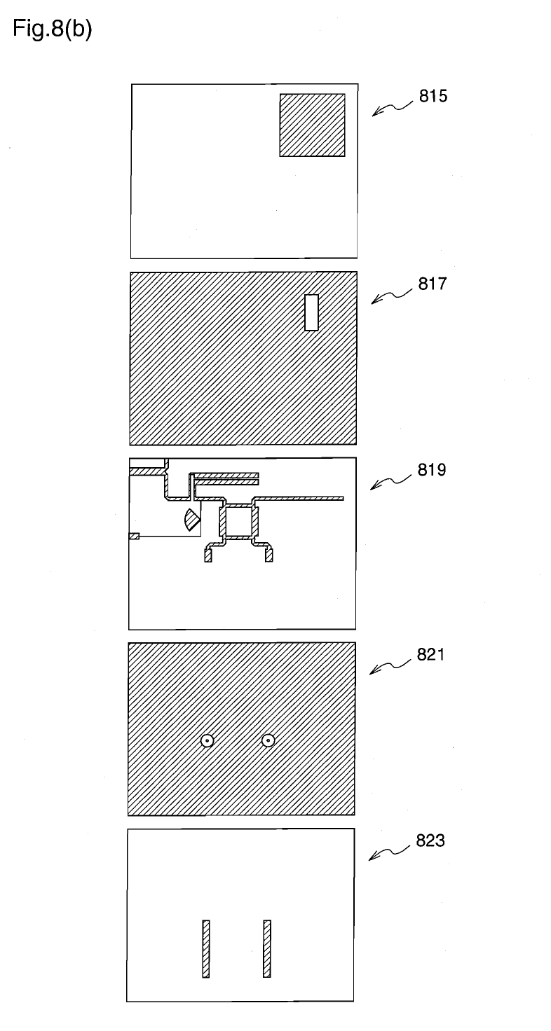

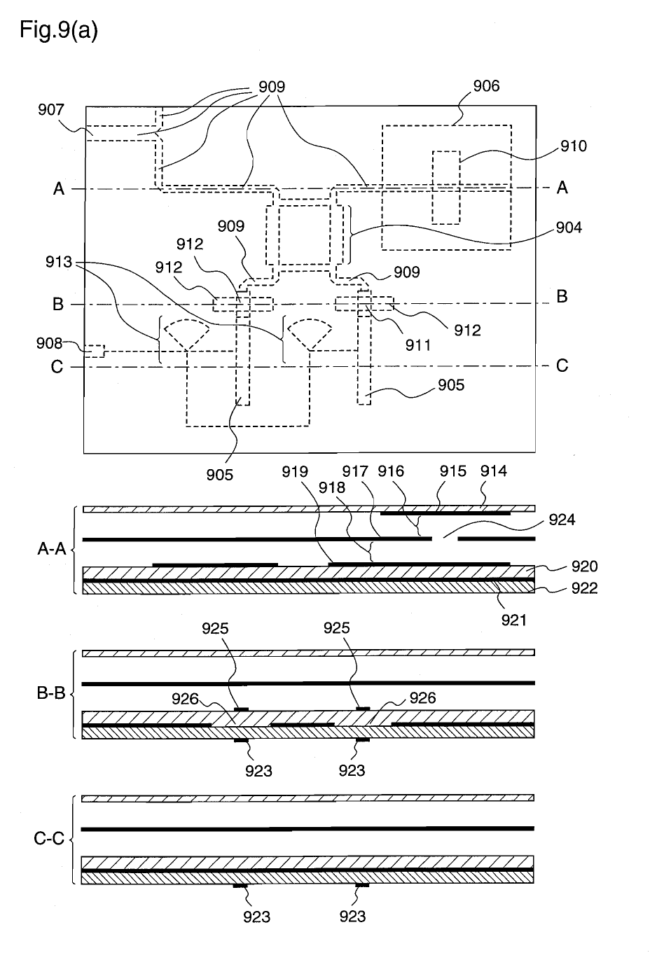

The feeding phase shift unit 308 comprises feeding ports 301, variable phase shifters 302 each including two propagation characteristic variable lines 115 which are disposed approximately parallel to each other as shown in FIG. 11, variable phase shifters 303 each including two propagation characteristic variable lines 115 which are disposed on approximately the same straight line as shown in FIG. 12, a phase shift amount controller (not shown), a high-frequency circuit 307, and a voltage generation circuit for variable dielectric (not shown).

In FIG. 10, 305 denotes an opening provided in the variable dielectric-constant dielectric layer of each variable phase shifter to be described later, and 306 denotes an assembly of variable phase shifters to be described later. The phased array antenna shown in FIG. 10 has plural variable phase shifters 302 and 303 each including plural variable dielectric-constant dielectric layers which are independent from each other as shown in FIG. 11.

More specifically, the phased array antenna shown in FIG. 10 includes forty-eight variable phase shifters shown in FIG. 11 (each phase shifter is denoted by 302), and sixteen variable phase shifters shown in FIG. 12 (each phase shifter is denoted by 303). The number of phase shifters is not restricted to that mentioned above, and it is determined according to the frequency of the used electromagnetic wave, the beam directional gain of the antenna, and the contact angle of beams.

Further, the configurations of the propagation characteristic variable phase shift lines 115 to be described later are not restricted to those shown in FIGS. 11 and 12 so long as the similar variable phase shift characteristics can be obtained in each row (horizontal direction in FIG. 11).

Each variable dielectric-constant dielectric layer has an opening 122 for injection of a liquid crystal. Generally, if the dielectric loss of the variable dielectric-constant dielectric substance is small, it is not necessary to constitute the division structure in which the feeding phase shift unit comprises plural independent variable dielectric-constant dielectric layers as in the present invention, and the variable dielectric-constant dielectric substance can be integrally formed over the surface of the phased array antenna.

However, the electric loss of a liquid crystal or a material including a liquid crystal as a variable dielectric-constant dielectric substance that satisfies the desired to form variable phase shifters having the same variable dielectric constant characteristic is as large as about 0.5 dB for each phase shifter, and the power gain of the antenna cannot be obtained if the variable dielectric-constant dielectric substance is provided also on the propagation characteristic fixed line part.

So, in the present invention (third embodiment), the variable dielectric-constant dielectric layer is disposed on only the area where the variable phase shifters are to be formed, thereby to reduce the dielectric loss as much as possible. On the other hand, the antenna unit includes plural antenna patch lines each comprising plural antenna patches 304, and the respective antenna patches 304 in each antenna patch line are connected with each other via connection lines 310 in the vertical direction in FIG. 10 to constitute the antenna patch line.

The specific construction of the variable phase shifter 302 in the phased array antenna of the present invention will be described with reference to FIG. 11. In FIG. 11, 110 denotes an input terminal of a propagation signal, 111 denotes feeding lines, 112 denotes a hybrid coupler, 113 denotes an antenna element, 114 denotes a binding window, 115 denotes propagation characteristic variable lines, 116 denotes bias voltage supply through holes, 117 denotes through hole lands, 118 denotes bias electrode planes (sub conductors), 119 denotes a bias line, 120 denotes a bias terminal, 121 denotes a variable dielectric-constant dielectric layer, and 122 denotes an opening of an open hole 144 to be described later.

The phase shifter 302 shown in FIG. 10 is constituted by the feeding lines 111, the hybrid coupler 112, and the two propagation characteristic variable lines 115 having approximately the same propagation characteristics. The variable dielectric-constant dielectric layer 121 of the present invention should be formed in an area including at least one propagation characteristic variable line 115 constituting one phase shifter.

In FIG. 11, the variable dielectric-constant dielectric layer 12 is formed in an area including the two propagation characteristic variable lines 115 (an area enclosed with dashed line in FIG. 11). The variable dielectric-constant dielectric layer 121 must be formed so as to have uniform dielectric characteristic over the entire area of the propagation characteristic variable line 115. Therefore, when a liquid crystal or a material including a liquid crystal is used as the variable dielectric-constant dielectric substance, the liquid crystal must be injected from the opening 122 so as to have uniform dielectric characteristic.

At least one opening 122 may be formed in each variable dielectric-constant dielectric layer 121. With respect to the position of the opening 122, a position that satisfies at least either of the following conditions is desirable, that is, a position outside a part of an arc having as a radius corresponding to a straight line connecting the center 116 of the propagation characteristic variable line 115 and the propagation characteristic variable line end 124 with the center 116 being the center of the opening, or a position that is outside the propagation characteristic variable line 115 and is apart by a distance of 3λ or more from the center 116 of the propagation characteristic variable line 115 within each variable dielectric-constant dielectric layer 121, assuming that the wavelength of the propagating electromagnetic wave signal is λ (a distance in which the electromagnetic signal intensity attenuates by 3 dB).

This is for minimizing the influence to the electromagnetic wave that propagates in the line having the opening 122. As a method for injecting the liquid crystal, a vacuum injection method or a capillary injection method which are publicly known as an injection method for a liquid crystal display device may be used.

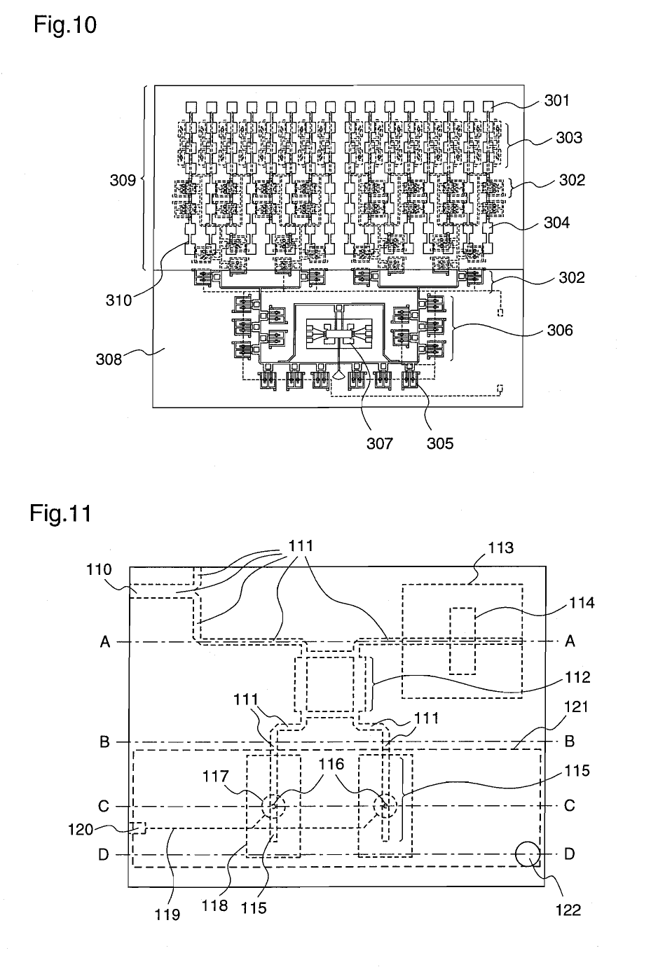

FIG. 11 is a plan view of a variable phase shifter in the case where a liquid crystal is injected by the vacuum injection method according to the present invention. The fabrication method is as follows. As shown in FIG. 10, the respective substrates for constituting the phased array antenna are bonded together by thermocompression, and then an open hole 144 (refer to FIG. 14) is formed by performing cutting in the vertical direction to the substrate surface opposite to the antenna surface (antenna unit 309) at a position corresponding to each variable dielectric-constant dielectric layer. An opening 122 of the open hole 144 is formed at the substrate surface.

Next, the liquid crystal injection method will be described specifically. Initially, tubes (not shown) for injecting the liquid crystal are connected to the openings 122 of the respective variable phase shifters. Next, the phased array antenna in the state where the tubes are connected to the openings 122 of the respective variable dielectric-constant dielectric layers 121 is put into a vacuum chamber, and the degree of vacuum is reduced to 10⁻¹ Torr or less.

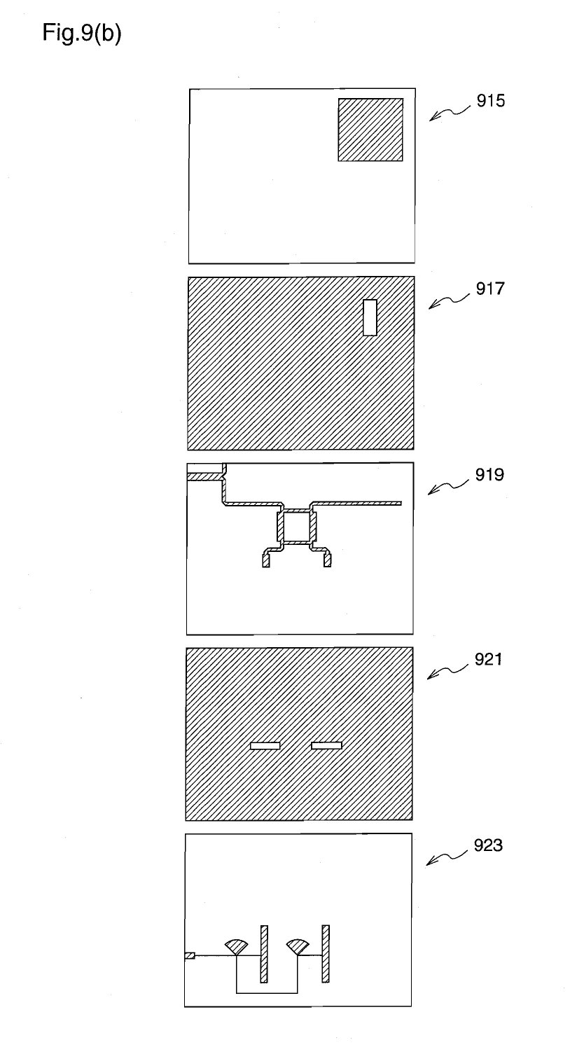

Next, all the tubes connected to the variable dielectric-constant dielectric layers are immersed into the liquid crystal stored in a container provided in the vacuum chamber, whereby the liquid crystal is absorbed toward the openings, and then injected into all the variable dielectric-constant dielectric layers 121 by restoring the chamber to the atmospheric pressure. Thereafter, the tubes are disconnected, and the openings 122 are sealed with a rapid-hardening epoxy strong adhesive, e.g., “Rapid Araldite” (produced by Huntsuman Advanced Materials Co., Ltd., and marketed by Showa Highpolymer Co., Ltd.), thereby completing the phased array antenna in which the variable dielectric-constant dielectric layers 121 are formed. FIG. 13 is a cross-sectional view illustrating the overall schematic structure of this phased array antenna.

By the way, in view of the dielectric loss, the conductor loss, and the insertion loss, the variable dielectric-constant dielectric layer 121 is desired to be provided in an area where the propagation characteristic variable lines 115 are formed (hereinafter referred to as a propagation characteristic variable line part). Accordingly, it is necessary to divide the variable dielectric-constant dielectric layer 121 into cells for each of the phase shifters 302 and 303, and encapsulate the liquid crystal into the cells so as not to provide the variable dielectric-constant dielectric layer 121 on the feeding line 111 other than the propagation characteristic variable lines 115. Accordingly, it is possible to reduce the coupling loss (comprising dielectric loss, conductor loss, and insertion loss) by dividing the variable dielectric-constant dielectric layer 121 into plural groups as described later.

Next, the A-A cross section, B-B cross section, C-C cross section, and D-D cross section of the variable phase shifter shown in FIG. 11 constituting the phased array antenna of the present invention will be described with reference to FIG. 14.

In the A-A cross-sectional view shown in FIG. 14, 130 denotes a first insulator layer. 131 denotes a conductor layer which functions as the antenna element 113 shown in FIG. 10. A Teflon (trademark) substrate is preferably used as the first insulator layer 130 in view of low dielectric loss. Further, a substrate obtained by impregnating a glass cloth with Teflon (trademark), a liquid crystal polymer substrate, an alumina ceramics substrate, an alumina composite substrate, or a sapphire substrate may be used as the first insulator layer 130.

When a glass epoxy substrate having a relatively high dielectric loss, such as FR4, is used as the first insulator layer 130, it is necessary to devise the configuration of the upper part of the antenna element such that an opening is formed in the insulator layer to form an air layer. A thin film or a thick film comprising a metal having a high electric conductivity such as copper, silver, or gold, or a metal alloy, a metal multilayer film, or a metal complex material may be used as the conductor layer 131.

132 denotes a binding window comprising an air layer, which corresponds to the binding window 114 shown in FIG. 11. 133 denotes a second insulator layer, and preferably, it comprises a Teflon (trademark) substrate in view of its low dielectric loss. Further, the second insulator layer 133 may be a substrate obtained by impregnating a glass cloth with Teflon (trademark), a liquid crystal polymer substrate; an alumina ceramics substrate, an alumina composite substrate, or a sapphire substrate.

134 denotes a ground conductor layer as a metal electrode, and it may comprise a thin film or a thick film comprising a metal having a high electric conductivity such as copper, silver, or gold, or a metal alloy, a metal multilayer film, or a metal complex material. 135 denotes a main conductor layer, which functions as a feeding line for the propagation characteristic fixed line or the propagation characteristic variable line 115. 136 denotes a third insulator layer, which preferably comprises a Teflon (trademark) substrate in view of its low dielectric loss.

A substrate obtained by impregnating a glass cloth with Teflon (trademark), a liquid crystal polymer substrate, an alumina ceramics substrate, an alumina composite substrate, or a sapphire substrate can also be used as the third insulator layer 136.

In the B-B cross-sectional view shown in FIG. 14, 135 denotes a main conductor layer. While in the A-A cross-sectional view the main conductor layer 135 is shown wide because it is disposed in the direction along the A-A line, in the B-B cross-sectional view it is shown narrow because it is disposed in the direction perpendicular to the B-B line.

In the C-C cross-sectional view shown in FIG. 14, 137 denotes is a main conductor layer which is similar to the main conductor layer 135 in the A-A cross-sectional view, and it functions as the propagation characteristic variable line 115 shown in FIG. 11. As the propagation characteristic variable line 137, a thin film or a thick film comprising a metal having a high electric conductivity such as copper, silver, or gold, or a metal alloy, a metal multilayer film, or a metal complex material as a metal electrode is used.

138 denotes a variable dielectric-constant dielectric layer which is constituted using a liquid crystal or a material including a liquid crystal. The liquid crystal may be a nematic liquid crystal, a cholesteric liquid crystal, or a smectic liquid crystal which has a large dielectric anisotropy, or a mixture crystal thereof, or a complex material obtained by mixing an inorganic material or an organic material into the liquid crystal to enhance the voltage response.

The inorganic material may be a metal oxide such as magnesium oxide (MgO), calcium oxide (CaO), strontium oxide (SrO), Barium oxide (BaO), Aluminum oxide (Al₂O₃), zirconium oxide (ZrO₂), Titan oxide (TiO₂), zinc oxide (ZnO), or a metal sulfide such as cadmium sulfide (CdS) or Zinc sulfide (ZnS), or a composite oxide such as SiO₂—MgO, SiO₂—CaO, Al₂O₃—MgO, SiO₂—Al₂O₃, SiO₂—TiO₂, TiO₂—ZrO₂, or a mixture of these materials.

The above-mentioned inorganic material may be dispersed as particles in the liquid crystal, or it may have a porous structure. The organic material may be acrylic resin, methacrylic resin, epoxy resin, urethan resin, polystyrene, polyvinyl alcohol, fluorine resin, or a copolymer of these materials.

Further, a mixture of the liquid crystal and the inorganic material or organic material may be used. 139 denotes a sub conductor layer, which functions as a bias electrode plane 118 for the variable dielectric-constant dielectric substance. A thin film or a thick film comprising a metal having a high electric conductivity such as copper, silver, or gold, or a metal alloy, a metal multilayer film, or a metal complex material is used as the sub conductor layer 139. The sub conductor layer 139 is connected to the conductor layer 141 via a metal plating in the bias electrode supply through-hole 140 (116 in FIG. 11) which is performed on the third insulator layer 136.

In the D-D cross-sectional view in FIG. 14, 144 denotes an open hole for injecting the liquid crystal. The open hole 144 is formed perpendicularly to the substrate surface starting from the variable dielectric-constant dielectric layer, and has an opening 122 at the substrate surface opposed to the antenna plane having the antenna element 113 comprising the conductor 131.

A bias voltage applied to the propagation characteristic variable line 137 (115 in FIG. 11) is applied from the bias terminal 120 through the bias line 119 and the metal plating on the bias voltage supply through-hole 140 to the sub conductor 139 (the bias line 119 in FIG. 11).

Accordingly, it is possible to control the voltage applied to the variable dielectric-constant dielectric substance 138 between the bias line 119 and the propagation characteristic variable line 115, and the dielectric constant of the variable dielectric-constant dielectric substance 138 can be varied by controlling the orientation of the liquid crystal constituting the dielectric substance 138 with the bias voltage, thereby enabling phase control.

The liquid crystal or the material containing a liquid crystal may be subjected to an orientation process along the planes 142 and 143 which are parallel with the line. This orientation process maximizes the dielectric anisotropy, and thereby the variable phase shift amount is maximized.

The above-mentioned orientation process may be carried out by methods which are publicly known in the field of liquid crystal display devices. For example, there may be adopted a method of applying polyimide or polyvinyl alcohol to the insulator planes 142 and 143, and rubbing the planes before fabricating a phased array antenna, or a method of expanding a resin containing a liquid crystal on the insulator planes 142 and 143 approximately in parallel with each other, or a method of scrubbing a resin containing a liquid crystal in one direction to physically form fine scratches.

Then, the liquid crystal subjected to the orientation process is injected from the opening 122 and then hermetically sealed, thereby producing the variable dielectric-constant dielectric layer having the orientation during power-off.

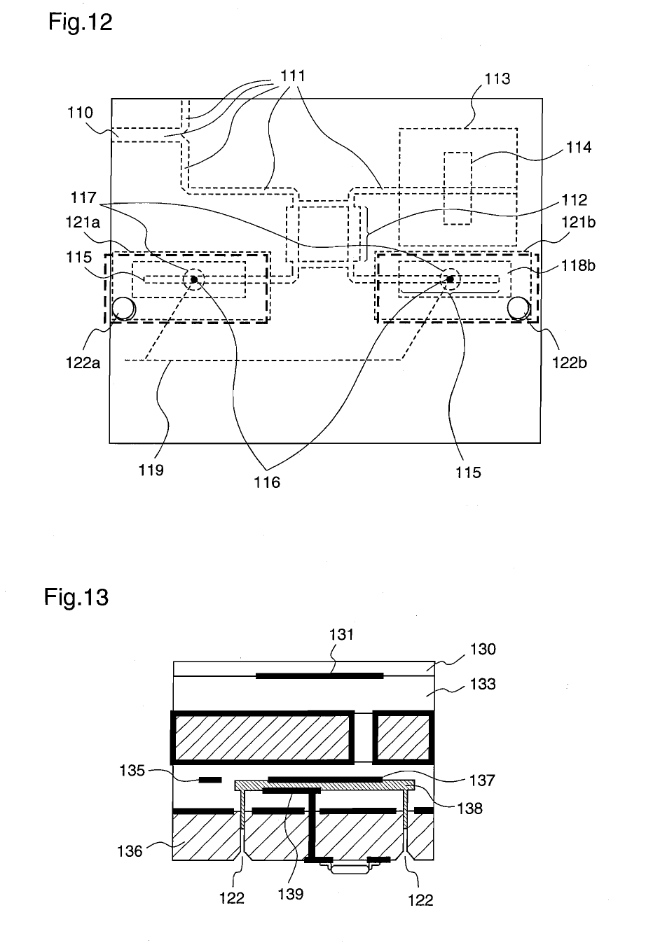

Hereinafter, a specific method for fabricating the above-described phased array antenna will be described with reference to FIG. 15.

Initially, the ground conductor layer 134 is formed on the second insulator layer 133 (refer to FIGS. 15(a) and 15(b)). Next, a conductor layer is formed over the main surface of the second insulator layer 133, which is opposite to the main surface of the second insulator layer 133 where the ground conductor layer 134 is formed, and the conductor layer is patterned to form the propagation characteristic fixed line 135 (refer to FIG. 15(c)). A groove is previously formed on the second insulator layer 133 at a position where the propagation characteristic fixed line 135 is to be formed.

Next, the second insulator layer 133 is bonded to the main surface of the second insulator layer 133 on which the propagation characteristic fixed line 135 is formed (refer to FIG. 15(d)). A concave part to be a liquid crystal container is previously formed by molding in a portion of the second insulator layer 133 to be the variable dielectric-constant dielectric layer 138 (refer to the left side of FIG. 15(d)).

Next, the third insulator layer 136 is formed beneath the second insulator layer 133 which is formed in the step of FIG. 15(d) (refer to FIG. 15(e)). Then, a groove is formed on the main surface of the third insulator layer 136 on the second insulator layer 133 side, and a conductor layer is formed over the entire surface including this groove, followed by patterning, thereby forming the sub conductor layer 139 (refer to the left side of FIG. 15(e)).

Next, the through-hole 140 filled with a conductor is formed in the third insulator layer 136 (refer to the left side of FIG. 15(f)), and the through-hole land 141 is formed on the main surface of the third insulator layer 136, which is opposite to the main surface of the third insulator layer 136 where the sub conductor layer 139 is formed, so as to cover the exposed surface of the through-hole 140 (refer to the left side of FIG. 15(g)).

Thereafter, the second insulator layer 133 to be disposed on the ground conductor layer 134 shown in FIG. 15(b) is prepared (refer to FIG. 15(h)), and the first insulator layer 130 is formed on the second insulator layer 133 (refer to FIG. 15(i)), and then the second insulator layer 133 is thermally adhered onto the structure shown in FIG. 15(g), thereby completing the phased array antenna.

Then, an open hole reaching a hollow (concave part) to be the variable dielectric-constant dielectric layer 138 is formed from the main surface of the completed phased array antenna where the land 141 is formed, and a liquid crystal or a material including a liquid crystal is injected into the hollow by a vacuum injection method or a capillary injection method, thereby forming the variable dielectric-constant dielectric layer 138 with reduced variation in the dielectric constant.

The process steps shown in FIGS. 15(a) to 15(g) and the process steps shown in FIGS. 15(h) and 15(i) may be performed in parallel with each other.

As described above, according to the third embodiment,

(1) since the variable dielectric-constant dielectric layer is constituted by uniformly injecting a liquid crystal dielectric, or a complex of a liquid crystal and an inorganic material, or a complex of a liquid crystal and a resin, or a fiber dielectric obtained by impregnating a plate member or a porous film with a liquid crystal, variations in the dielectric constants of the plural variable phase shifters can be reduced, and thereby the plural variable phase shifters which can be controlled with a single application voltage is realized, resulting in a plane antenna having excellent beam-tilt characteristics.

(2) Further, since the variable dielectric-constant dielectric layers contacting the propagation characteristic variable lines are disposed only in the area where the variable phase shifters are formed, a plane antenna having reduced dielectric loss and preferable beam directional gain can be provided.

### Embodiment 4

Hereinafter, a fourth embodiment of the present invention will be described with reference to FIG. 12. This fourth embodiment is different from the third embodiment (FIG. 11) in the configuration of the propagation characteristic variable line 115.

FIG. 12 is a plan view of a variable phase shifter 303 which is used in the phased array antenna shown in FIG. 10. FIG. 12 is different from FIG. 11 in that a pair of propagation characteristic variable lines 115 are disposed separated from each other on the same straight line. Further, as the pair of propagation characteristic variable lines 115 are disposed apart from each other, the variable dielectric-constant dielectric layer 121 constituting the variable phase shifter is divided into two parts.

In FIG. 12, 110 denotes an input terminal of a propagation signal, 111 denotes feeding lines, 112 denotes a hybrid coupler, 113 denotes an antenna element, 114 denotes a binding window, 115 denotes propagation characteristic variable lines, 116 denotes bias voltage supply through-holes, 117 denotes through-hole lands, 118 denotes a bias electrode plane (sub conductor), 119 denotes a bias line, 121a and 121b denote variable dielectric-constant dielectric layers, and 122a and 122b denote openings.

The phase shifter 303 comprises the feeding lines 111, the hybrid coupler 112, and the two propagation characteristic variable lines 115 having approximately the same propagation characteristics. The openings 122a and 122b are obtained by forming open holes perpendicularly to the respective variable dielectric-constant dielectric layers 121a and 121b starting from the dielectric layers, and thereby the openings 122a and 122b are formed at the substrate surface opposed to the surface of the antenna element 113. In the case where one opening 122 is formed in one variable dielectric-constant dielectric layer 122, the phase shifter 303 can be fabricated by injecting the liquid crystal by the vacuum injection method as in the first embodiment.

As described above, according to the fourth embodiment, in the phased array antenna including the propagation characteristic variable lines 115 whose configurations are different from those of the first embodiment, a liquid crystal or a complex material including a liquid crystal is injected by a vacuum injection method or a capillary injection method into the variable dielectric-constant dielectric layers constituting the phase shifters of the phased array antenna. Therefore, variations in the dielectric constants of the plural variable phase shifters can be reduced, and thereby the plural variable phase shifters which can be controlled with a single application voltage are realized, resulting in a plane antenna having excellent beam-tilt characteristic.

Further, since the variable dielectric-constant dielectric layers contacting the propagation characteristic variable lines are disposed on only the area where the variable phase shifters are formed, a plane antenna with reduced dielectric loss and preferable beam directional gain can be provided.

### Embodiment 5

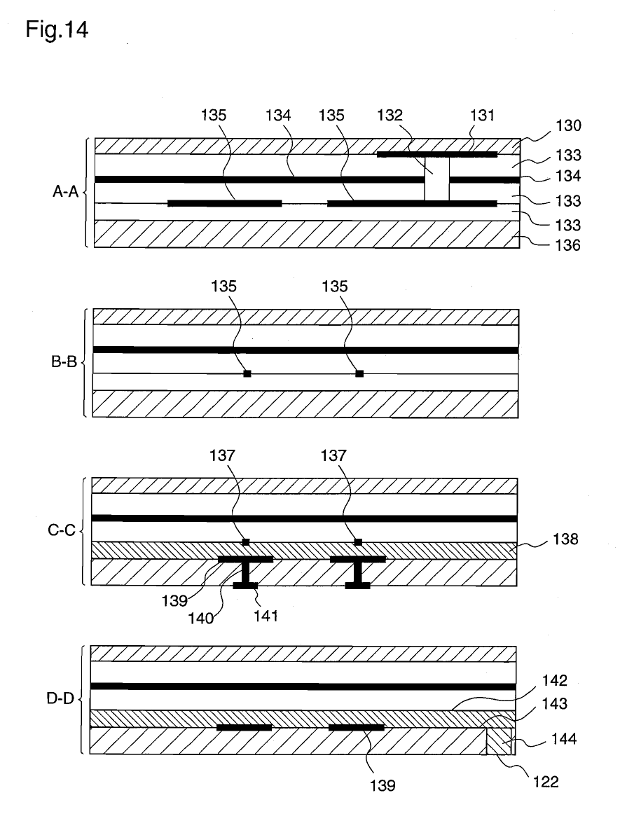

Hereinafter, a fifth embodiment of the present invention will be described with reference to FIG. 16.

A difference between the fifth embodiment (FIG. 16) and the fourth embodiment (FIG. 12) resides in the number of openings 122 of the variable dielectric-constant dielectric layer. When the capillary injection method is used as the liquid crystal injection method, at least two openings 122, i.e., an exhaust port and a liquid crystal suction port, are required as is publicly known for the liquid injection method for liquid crystal display devices.

That is, when one propagation characteristic variable line is included in the variable dielectric-constant dielectric layer, at least a pair of openings are formed at positions that are approximately opposed to each other with respect to the center of the propagation characteristic variable line. Assuming that the first opening is 122 and the second opening is 123, these openings for the variable phase shifter are formed such that the second opening 123 is formed at a position opposed to the first opening 122 with respect to the bias voltage supply through-hole 116 which is disposed in the center of the propagation characteristic variable line 115. It is arbitrary to use either of the openings 122 and 123 as either of the exhaust port or the liquid crystal suction port.

By injecting a liquid crystal or a material including a liquid crystal from the suction port while decreasing the pressure from the exhaust port, the liquid crystal or the material including a liquid crystal can be uniformly injected into the liquid crystal container.

Further, as shown in FIG. 16, when the pair of openings are formed diagonally in the area where the liquid crystal container is formed, the distance between the openings is increased as compared with the case where the openings are formed at other positions. Thereby, even when bubbles remain in the injected liquid crystal, adverse influences of the bubbles on variations in the dielectric constant can be minimized.

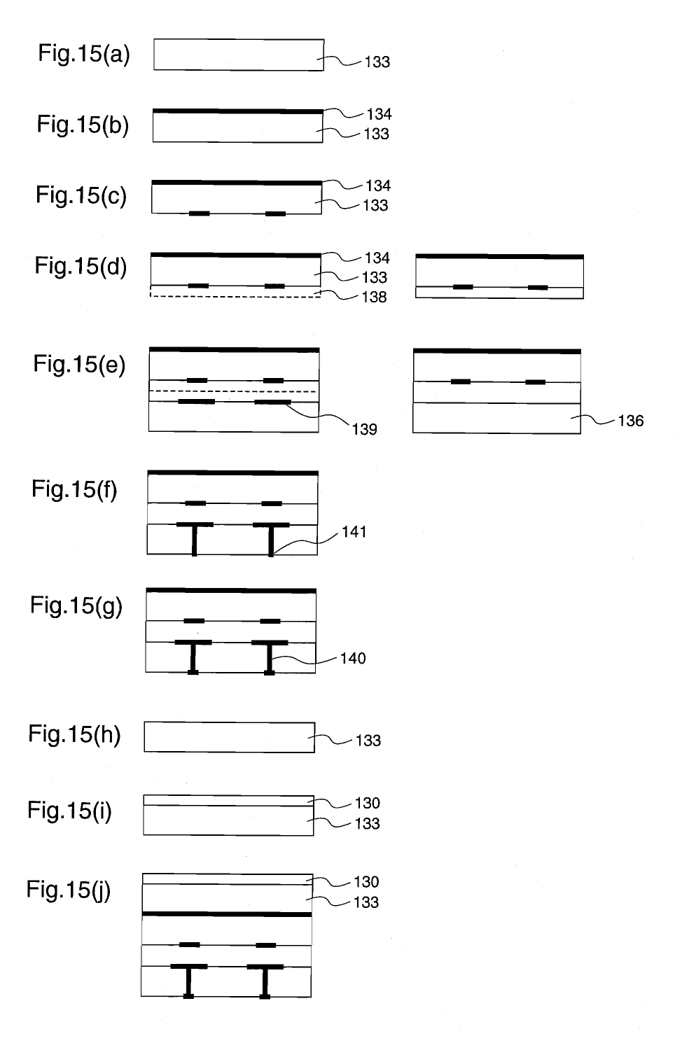

Next, FIG. 17 is a diagram for explaining the layout of the two openings 122 in the case where plural propagation characteristic variable lines 115 (two in FIG. 17) are disposed within the variable dielectric-constant dielectric layer 121.

In FIG. 17, 215a denotes a first propagation characteristic variable line, and 215b denotes a second propagation characteristic variable line. The openings 122 are disposed opposed to each other in a diagonal line, outside the area constituted by the propagation characteristic variable lines 215a and 215b in the variable dielectric-constant dielectric layer 121. The positions of the openings 122a and 122b are preferably in the variable dielectric-constant dielectric layer 121 outside the propagation characteristic variable lines 215a and 125b, respectively.

More preferably, the openings 122a and 122b are disposed at positions 3λ or more apart from the propagation characteristic variable lines which are close to each other. Here, λ is the wavelength of the electromagnetic wave signal that propagates on the propagation characteristic variable line. When the openings 122 are 3λ apart from the propagation characteristic variable lines 215a and 215b, the intensity of the electromagnetic wave signal is reduced by 3 dB, whereby the influence of the openings 122 on the propagation characteristic variable lines can be reduced. While in this fifth embodiment two propagation characteristic variable lines are provided, the fifth embodiment is also applicable to the case where three or more propagation characteristic variable lines are provided.

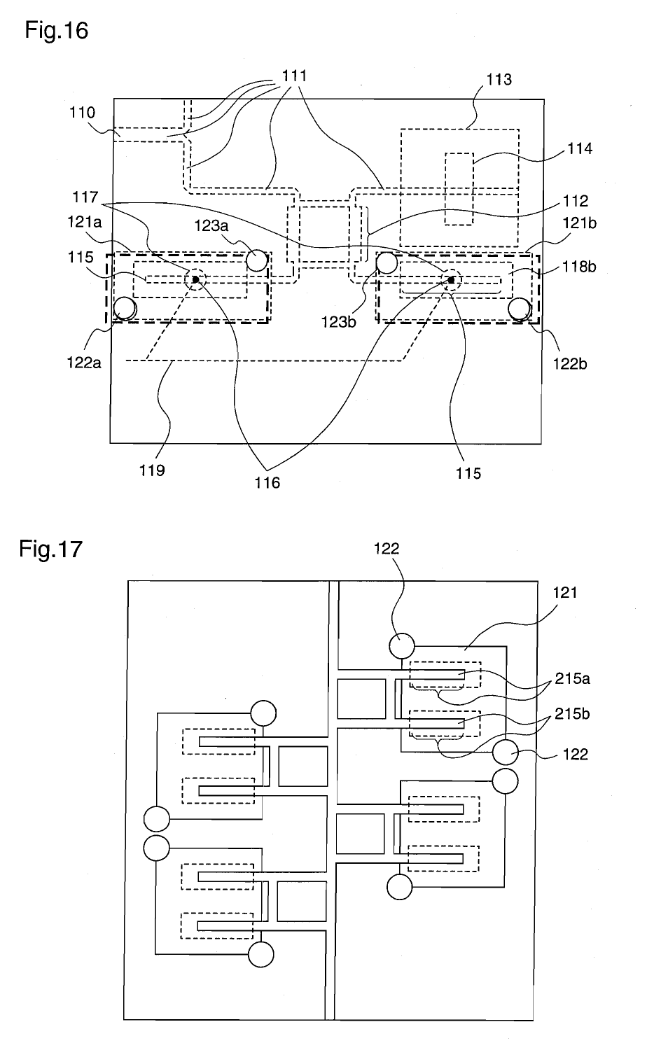

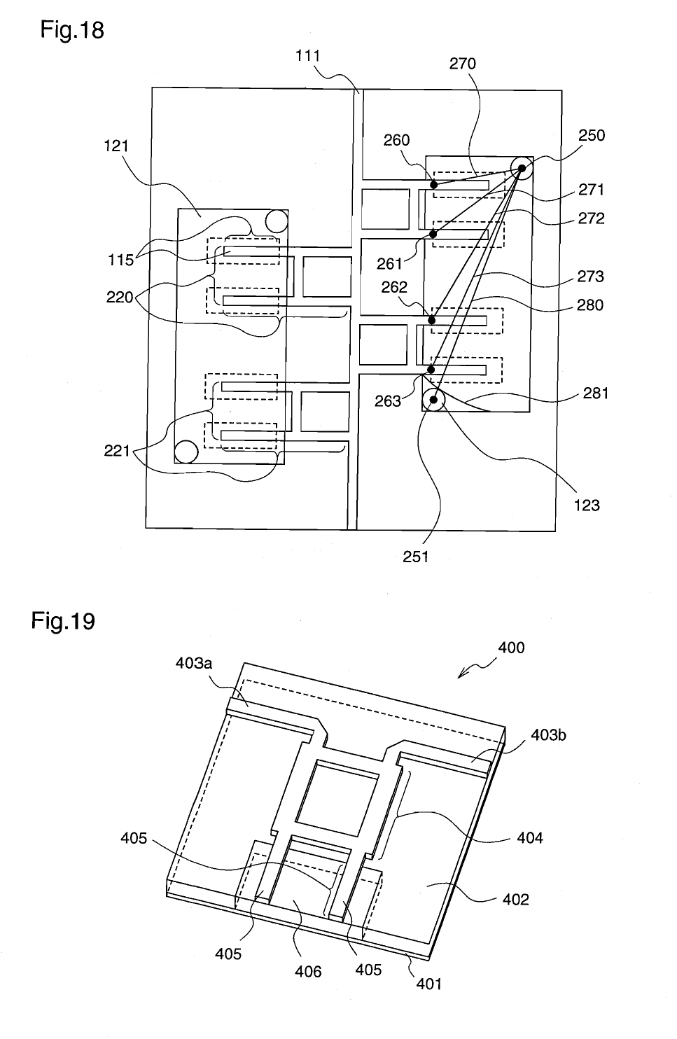

Further, FIG. 18 shows the case where one variable dielectric-constant dielectric layer 121 is shared by adjacent two variable phase shifters. The number of variable phase shifters that share the variable dielectric-constant dielectric layer 121 may be arbitrarily selected so long as the variable dielectric-constant dielectric layer 121 does not intersect with the propagation characteristic fixed lines, i.e., those lines which are the feeding lines 111 other than the propagation characteristic variable lines 115.

When the liquid crystal as the variable dielectric-constant dielectric layer 121 is injected by the vacuum injection method, the number of openings 122 may be at least one for each variable dielectric-constant dielectric layer. The opening 122 may be positioned on the substrate surface opposed to the antenna surface.

On the other hand, when the liquid crystal is injected by the capillary injection method, it is necessary to provide two openings 122, i.e., an exhaust port and an injection port, for each variable dielectric-constant dielectric layer 121. Hereinafter, a description will be given of preferable positions of the openings 122 in the case where the liquid crystal is injected by the capillary method, with reference to FIG. 18.

In FIG. 18, 121 denotes a variable dielectric-constant dielectric layer, 122 denotes a first opening, 123 denotes a second opening, 250 denotes the center of the first opening 122, 251 denotes the center of the second opening 123, 260 denotes a first propagation characteristic variable line end, which is an intersection point (closest propagation characteristic variable line end) between the propagation characteristic variable line closest to the first opening 122 and the variable dielectric-constant dielectric layer 121. 270 denotes a straight line connecting the center 250 of the first opening and the intersection point 260, having a length L1.

Likewise, 261 denotes a second propagation characteristic variable line end, which is a second intersection point between the propagation characteristic variable line secondary closest to the first opening 122 and the variable dielectric-constant dielectric layer 121. 271 denotes a straight line connecting the center 250 of the first opening and the intersection point 261, having a length L2. Likewise, 262 and 263 denote third and fourth propagation characteristic variable line ends, which are intersection points between the propagation characteristic variable lines thirdly and fourthly closest to the first opening 122 and the variable dielectric-constant dielectric layer 121, respectively. 272 and 273 denote straight lines connecting the center 250 of the first opening and the intersection points 262 and 263, respectively, and the lengths of the straight lines 272 and 273 are L3 and L4, respectively.

280 denotes a straight line connecting the center 250 of the first opening 122 and the center 251 of the second opening 123, having a length L0. A curve 281 is an arc having, as its radius, the straight line of the length L0 in the variable dielectric-constant dielectric layer 121, from the center 250 of the first opening.

By disposing the second opening 123 outside the arc 281 in the variable dielectric-constant dielectric layer 121, i.e., by arranging the second opening 123 so as to satisfy the relationship of L0>L4>L3>L2>L1, influences of the propagation characteristic variable line on the electromagnetic wave can be suppressed.

By adopting the above-described layout and fabrication method, the liquid crystal can be uniformly injected into the common variable dielectric-constant dielectric layer 121.

As described above, according to the fifth embodiment, a pair of openings are formed reaching the variable dielectric-constant dielectric layer constituting each variable phase shifter in the phased array antenna, and a liquid crystal or a complex material including a liquid crystal is injected by the capillary injection method. Therefore, variations in the dielectric constants of plural variable phase shifters are reduced, and thereby plural variable phase shifters which can be controlled with a single application voltage are realized, resulting in a plane antenna having excellent beam tilt characteristics.

While in the third to fifth embodiments microstrip lines are described as examples of variable phase shifters, transmission lines of the present are not restricted to microstrip lines, and the third to fifth embodiments are applicable to all transmission lines using a dielectric material as a high frequency signal transmitting medium, such as coplanar lines or strip lines having plural individual variable phase shifters.

While the present invention has been specifically described with respect to the first to fifth embodiments, the present invention is not restricted to the first to fifth embodiments, and various changes may be made without departing from the scope of the invention.

### APPLICABILITY IN INDUSTRY

As described above, the present invention relates to a phased array antenna having variable phase shifters constituted by using a variable dielectric-constant dielectric substance whose dielectric constant varies according to an applied electric field, and the phased array antenna is characterized by that it requires no DC blocking element which causes a mismatch, and thereby maintains a high directional gain with less deformation of the beam shape even when beam tilt occurs in the case where the antenna is constituted such that the variable phase shifters are divided into variable phase shifters for right-side tilt and variable phase shifters for left-side tilt and the phase shift amounts thereof are independently controlled to realize a high directional gain. Therefore, it is useful as an antenna for in-vehicle radar or satellite communication.

Further, the phased array antenna of the present invention can uniformly constitute a variable dielectric-constant dielectric substrate which constitutes variable phase shifters by using a liquid crystal or a material including a liquid crystal, thereby providing a phased array antenna which can minimize the dielectric loss, and maintain a high directional gain with less deformation of the beam shape even when beam tilt occurs. Therefore, it is useful as an antenna for in-vehicle radar or satellite communication, or a millimeterwave sensor.

1. A phased array antenna having variable phase shifters constituted by using a variable dielectric-constant dielectric substance whose dielectric constant varies according to an applied electric field, including:
a feeding phase shift unit having a laminated structure formed by laminating at least a ground conductor layer, an insulator layer, a main conductor layer, a variable dielectric-constant dielectric layer, and a sub conductor layer in this order.

2. A phased array antenna as defined in claim 1 wherein
said feeding phase shift unit includes:
a propagation characteristic fixed line which does not vary the propagation characteristics of a high-frequency power, and
a propagation characteristic variable line which varies the propagation characteristics of the high-frequency power.

3. A phased array antenna as defined in claim 2 wherein
said propagation characteristic fixed line has no line in an area on the sub conductor layer which corresponds to a line provided on the main conductor layer, and propagates an electric field produced by the high-frequency power that propagates in the line provided on the main conductor layer, concentratedly to between the main conductor layer and the ground conductor layer,
said propagation characteristic variable line has a line in the area on the sub conductor layer which corresponds to the line provided on the main conductor layer, and propagates the electric field produced by the high-frequency power that propagates in the line provided on the main conductor layer, dispersively to between the main conductor layer and the ground conductor layer and to between the main conductor layer and the sub conductor layer, and
said propagation characteristic fixed line and said propagation characteristic variable line are constituted as continuous conductors on the main conductor layer.

4. A phased array antenna as defined in claim 3 wherein
said propagation characteristic variable line applies a bias voltage to between the main conductor layer and the sub conductor layer to vary the dielectric constant of the variable dielectric-constant dielectric substance constituting the variable dielectric-constant dielectric layer, thereby controlling the propagation characteristics of the high-frequency power.

5. A phased array antenna as defined in claim 1 wherein said variable dielectric-constant dielectric layer comprises a liquid crystal or a material including a liquid crystal.

6. A phased array antenna as defined in claim 1 wherein
said laminated structure includes a second insulator layer which is disposed on a side of the sub conductor layer opposite to the variable dielectric-constant dielectric layer, and
said variable dielectric-constant dielectric layer is held in a hermetically-sealed space which is formed between the insulator layer and the second insulator layer.

7. A phased array antenna having variable phase shifters constituted by using a variable dielectric-constant dielectric substance whose dielectric constant varies according to an applied voltage, including:
a feeding phase shift unit having a laminated structure obtained by laminating at least a ground conductor layer, an insulator layer, a propagation characteristic variable line, a variable dielectric-constant dielectric layer, and a bias electrode layer in this order, wherein
said feeding phase shift unit includes plural independent variable-dielectric-constant dielectric layers,
each variable dielectric-constant dielectric layer has an open hole, and
said open hole is formed in the vertical direction with respect to a main surface of the phased array antenna, and has an opening on a main surface opposite to the main surface.

8. A phased array antenna as defined in claim 7 wherein
said feeding phase shift unit includes one propagation characteristic variable line in the variable dielectric-constant dielectric layer, and
at least a pair of said openings are formed at positions which are opposed to each other with respect to the center of the propagation characteristic variable line.

9. A phased array antenna as defined in claim 7 wherein
said feeding phase shift unit includes plural propagation characteristic variable lines in the variable dielectric-constant dielectric layer, and
at least a pair of said openings are formed opposed to each other at positions outside the plural propagation characteristic variable lines.

10. A phased array antenna as defined in claim 7 wherein
said opening is provided in the variable dielectric-constant dielectric layer outside an arc having a radius which corresponds to a straight line connecting the center of the propagation characteristic variable line and the propagation characteristic variable line end.

11. A phased array antenna as defined in claim 7 wherein
said opening is provided at a position within the variable dielectric-constant dielectric layer, said position being apart from the propagation characteristic variable line by a distance at least three times as long as a distance corresponding to the wavelength of the electromagnetic wave that propagates in the propagation characteristic variable line.

12. A phased array antenna as defined in claim 7 wherein said variable dielectric-constant dielectric layer comprises a liquid crystal or a material including a liquid crystal.

13. A phased array antenna as defined in claim 12 wherein said variable dielectric-constant dielectric layer is formed by injecting a liquid crystal or a material including a liquid crystal via the opening.
